(19) United States
(12) Patent Application Publication
(10) Pub. No.: US 2025/0068001 A1
(43) Pub. Date: Feb. 27, 2025

(54) Phase Shifting Components and Systems

(71) Applicant: PsiQuantum Corp., Palo Alto, CA (US)

(72) Inventor: Chia-Ming Chang, Palo Alto, CA (US)

(21) Appl. No.: 18/943,708

(22) Filed: Nov. 11, 2024

Related U.S. Application Data
(63) Continuation of application No. PCT/US2023/022145, filed on May 12, 2023.
(60) Provisional application No. 63/430,988, filed on Dec. 7, 2022.
(60) Provisional application No. 63/341,374, filed on May 12, 2022.

(51) Int. Cl. G02F 1/01; G02F 1/19

(52) U.S. Cl. CPC G02F 1/011; G02F 1/0147; G02F 1/19; G02F 2201/12; G02F 2202/32; G02F 2203/50

(57) ABSTRACT

The various embodiments described herein include a phase shifter that can have a first electrode that has a distributed shape. The phase shifter can include a second electrode. The phase shifter can include an optical waveguide between the first electrode and the second electrode. Further, the phase shifter can include an active electro-optical material that propagates light, and phase shifts the light.

### PRIORITY AND RELATED APPLICATIONS

This application is a continuation of PCT Patent Application Serial No. PCT/US2023/022145, filed May 12, 2023, which claims the benefit of and to priority to U.S. Provisional Patent Application No. 63/430,988, entitled “Photonic Switch-Based Information Processing” filed Dec. 7, 2022, and to U.S. Provisional Patent Application No. 63/341,374, entitled “Generalized Mach-Zehnder Interferometer Systems and Components” filed May 12, 2022, each of which is hereby incorporated by reference in its entirety.

### TECHNICAL FIELD

The present application relates generally to phase shifting components, including but not limited to phase shifting components for optical systems.

### BACKGROUND

A quantum computing system performs general computing according to principles of quantum mechanics. A classical computing system uses binary bits and encodes, stores, and processes data where each bit is 0 or 1. A quantum computing system is based on qubits, where each qubit can be in a superposition state of quantum states.

In optical quantum computing and quantum information processing, a single photon can be used as a qubit. However, routing and timing of single photons is challenging. Additionally, it is difficult to implement photodetectors that are sensitive enough to detect individual photons.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 shows an example photonic switch-based information processing system in accordance with some embodiments.

FIGS. 2A-2C show example quantum light switch architectures in accordance with some embodiments.

FIG. 2D shows an example cross-sectional view of photonic circuit components in accordance with some embodiments.

FIGS. 3A-3C show example generalized Mach-Zehnder interferometer (GMZI) architectures in accordance with some embodiments.

FIGS. 4 and 5 show example GMZI configurations in accordance with some embodiments.

FIGS. 6A and 6B show example GMZI components and configurations in accordance with some embodiments.

FIG. 7 shows example bends in a GMZI in accordance with some embodiments.

FIG. 8 is a block diagram showing an example GMZI with fast and slow phase shifters in accordance with some embodiments.

FIGS. 9A-9D are top-down views of example phase shifter configurations in accordance with some embodiments.

FIG. 10 is a cross-sectional view of an example phase shifter configuration in accordance with some embodiments.

FIG. 11 shows example protrusions to modify inductance in accordance with some embodiments.

FIG. 12 shows example protrusions to modify capacitance in accordance with some embodiments.

FIG. 13 shows an example capacitive protrusion in accordance with some embodiments.

In accordance with common practice, the various features illustrated in the drawings are not necessarily drawn to scale, and like reference numerals can be used to denote like features throughout the specification and figures.

### DETAILED DESCRIPTION

Phase shifters are an important building block for photonic quantum computing systems. For example, phase shifters can be used in generalized Mach-Zehnder interferometer (GMZI) systems, time-bin encoding systems, and any other photon manipulation components. It is desirable for the phase shifters to accurately and precisely change a phase of photons as well as operate at high speeds (e.g., in a gigahertz range) in some photonic quantum computing systems (e.g., switching networks and/or time-bin encoding circuits). The embodiments disclosed herein include phase shifter designs and structures that are capable of operating at high speeds and providing accurate and precise outputs.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

A generalized Mach-Zehnder interferometer (GMZI) is a building block for various quantum computing systems and/or optical communication systems. A GMZI may be implemented using splitter networks and phase shifters to perform routing of light, such as quantum light. The splitter networks may comprise sets of couplers, bends, and crossing couplers to manipulate the quantum light. In some embodiments, a first coupler network separates the quantum light, and a second coupler network combines the quantum light onto one or more output ports. In some embodiments, between the coupler networks are phase-shifter elements (e.g., passive phase shifter, fast phase shifter, slow phase shifter) to change a phase of the quantum light on a given arm of the GMZI such that the quantum light is configured according to a transfer matrix and output from the GMZI in various configurations, such as a N-to-1 configuration or a N-to-M configuration. In some embodiments, the electrodes of an optical phase shifters operate as lumped electrodes, where the bandwidth of the phase shifter is limited by the RC time constant of the lumped electrodes. In some example embodiments, the electrodes have a shape to increase or decrease capacitance to match the velocity of the light in the waveguide. In some example embodiments, the distributed electrodes receive radio frequency electrical signaling which operates the phase shifter as a traveling wave phase shifter. In the traveling wave configuration, the electrodes with the distributed shape that receive the RF signaling function as small transmission lines, such that the modulation is not limited by the capacitance (e.g., capacitance in the RC time constant), which can be modified by shaping protrusions from the electrodes. In some example embodiments, the traveling wave phase shifter with shaped modulators are limited only by RF losses. If the electrical RF losses are reduced (e.g., by using metals with high conductivity) then the phase shifter device is not limited by the RC time constant and bandwidth of the phase shifter can be further increased, in accordance with some example embodiments.

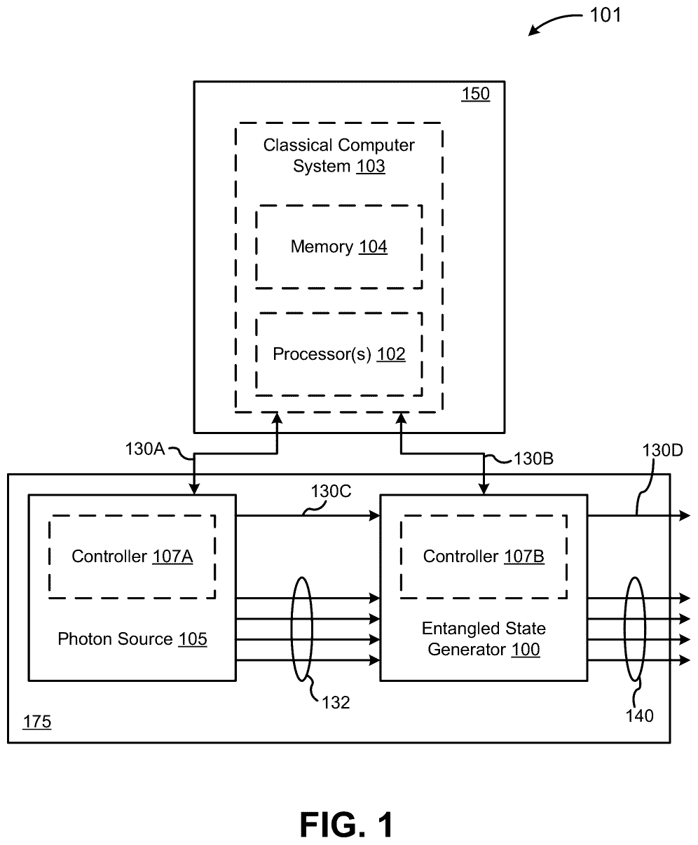

FIG. 1 shows a photonic switch-based information processing system 101 according to some embodiments. In some embodiments, the photonic switch-based information processing system 101 comprises an electronic information processing architecture 150 and a photonic processing architecture 175. The electronic information processing architecture 150 may process information electronically (e.g., binary data processing in a circuit, an ASIC, or with one or more central processing units and memory that stores instructions). The photonic processing architecture 175 may process information optically (e.g., classical light information processing such as Pulse Amplitude Modulation (PAM), Phase Shift Keying (PSK), or Quadrature Amplitude Modulation (QAM) signaling of light beams, or non-classical light information processing that uses extremely low levels of light, such as single-photon or entangled-photon processing and detection).

The photonic switch-based information processing system 101 may be used to generate qubits (e.g., photons) in an entangled state (e.g., a GHZ state or a Bell pair state) in accordance with some embodiments. In an example photonic architecture, the photonic switch-based information processing system 101 may include a photon source module 105 that is optically connected to the entangled state generator 100. Both the photon source module 105 and the entangled state generator 100 may be coupled to a classical computing system 103 such that the classical computing system 103 may communicate and/or control the photon source module 105 and/or the entangled state generator 100. The communication and/or control may be via the classical information channels 130A or 130B. The photon source module 105 may include a collection of single-photon sources. The single-photon sources may provide output photons to the entangled state generator 100 by way of one or more interconnecting waveguides 132. The entangled state generator 100 may receive the output photons and convert them to one or more entangled photonic states. Then, entangled state generator 100 may output these entangled photonic states into one or more output waveguides 140. In some embodiments, the output waveguides 140 are coupled to one or more downstream circuit that use the entangled states to perform a quantum computation. For example, the entangled states generated by the entangled state generator 100 may be used as resources for a downstream quantum optical circuit.

In some embodiments, the photonic switch-based information processing system 101 includes one or more classical information channels 130 (e.g., classical information channels 130A-D) for interconnecting and providing classical information between components. It should be noted that classical information channels 130A-130D need not all be the same. For example, one or more of the classical information channels 130A-130C may comprise a bi-directional communication bus carrying one or more reference signals, e.g., one or more clock signals, one or more control signals, or one or more signals that carries classical information, e.g., heralding signals or photon detector readout signals.

In some embodiments, the photonic switch-based information processing system 101 includes the classical computer system 103 that communicates with and/or controls the photon source module 105 and/or the entangled state generator 100. For example, in some embodiments, a classical computer system 103 is used to configure one or more circuits, e.g., providing a system clock the photon source module 105, the entangled state generator 100, or downstream quantum photonic circuits used for performing quantum computation. In some embodiments, the quantum photonic circuits may include optical circuits or electrical circuits. In some embodiments, a classical computer system 103 includes memory 104, one or more processor(s) 102, a power supply, an input/output (I/O) subsystem, and one or more communication busses for interconnecting these components. The processor(s) 102 may execute modules, programs, and/or instructions stored in the memory 104 and thereby perform processing operations.

In some embodiments, the memory 104 stores one or more programs (e.g., sets of instructions) and/or data structures. In some embodiments, the entangled state generator 100 attempts to produce an entangled state over successive stages, any one of which may be successful in producing an entangled state. In some embodiments, memory 104 stores one or more programs for determining whether a respective stage was successful and configuring the entangled state generator 100 accordingly. For example, upon determining that a respective stage was successful, the entangled state generator 100 is configured to switch the photons to an output. In another example, upon determining that a respective stage was not successful, the entangled state generator 100 is configured to pass the photons to the next stage of the entangled state generator 100. In some embodiments, the memory 104 stores detection patterns (described below). Based on the detection patterns, the classical computing system 103 may determine whether a stage was successful. In addition, the memory 104 may store settings that are provided to the various configurable components (e.g., switches) described herein that are configured by, e.g., setting one or more phase shifts for the component.

In some embodiments, some or all of the above-described functions are implemented with hardware circuits on the photon source module 105 and/or the entangled state generator 100. In some embodiments, a photon source module 105 includes one or more controllers 107A (e.g., logic controllers) (e.g., field programmable gate arrays (FPGAs), application specific integrated circuits (ASICS), or a “system on a chip” that includes classical processors and memory). In some embodiments, the controller 107A determines whether the photon source module 105 was successful (e.g., for a given attempt on a given clock cycle, described below) and outputs a reference signal indicating whether the photon source module 105 was successful. In some embodiments, the controller 107A outputs a logical high value to the classical information channel 130A and/or the classical information channel 130C when the photon source module 105 is successful and outputs a logical low value to the classical information channel 130A and/or the classical information channel 130C when the photon source module 105 is not successful. In some embodiments, the output of the controller 107A is used to configure hardware in the controller 107B.

In some embodiments, the entangled state generator 100 includes one or more controllers 107B (e.g., logical controllers) (e.g., which may comprise field programmable gate arrays (FPGAs), application specific integrated circuits (ASICS), or the like) that determine whether a respective stage of entangled state generator 100 has succeeded, perform the switching logic described above, and output a reference signal to the classical information channels 130B and/or 130D to inform other components as to whether the entangled state generator 100 has succeeded.

In some embodiments, a system clock signal is provided to the photon source module 105 and the entangled state generator 100 via an external source or by the classical computing system 103 via the classical information channels 130A and/or 130B. In some embodiments, the system clock signal provided to the photon source module 105 triggers the photon source module 105 to attempt to output one photon per waveguide. In some embodiments, the system clock signal provided to the entangled state generator 100 triggers, or gates, sets of detectors in the entangled state generator 100 to attempt to detect photons. For example, triggering a set of detectors in the entangled state generator 100 to attempt to detect photons includes gating the set of detectors.

In some embodiments, the photon source module 105 and/or the entangled state generator 100 has an internal clock. For example, the photon source module 105 may have an internal clock generated and/or used by the controller 107A, and the entangled state generator 100 may have an internal clock generated and/or used by the controller 107B. In some embodiments, the internal clock of the photon source module 105 and/or the entangled state generator 100 is synchronized to an external clock (e.g., the system clock provided by the classical computer system 103) (e.g., through a phase-locked loop). In some embodiments, any of the internal clocks may be used as the system clock, e.g., an internal clock of the photon source may be distributed to other components in the system and used as the master/system clock.

In some embodiments, the photon source module 105 includes a plurality of probabilistic photon sources that are spatially and/or temporally multiplexed (e.g., multiplexed single photon sources). In one example of such a source, the source is driven by a pump, e.g., a light pulse, which is coupled into an optical resonator that, through some nonlinear process (e.g., spontaneous four wave mixing or second harmonic generation) generates zero, one, or more photons. As used herein, the term “attempt” is used to refer to the act of driving a photon source with some sort of driving signal, e.g., a pump pulse, that may produce output photons non-deterministically (e.g., in response to the driving signal, the probability that the photon source will generate one or more photons may be less than 1). In some embodiments, a respective photon source may be most likely to, on a respective attempt, produce zero photons (e.g., there may be a 90% probability of producing zero photons per attempt to produce a single photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources is increased by using a plurality of single-photon sources and multiplexing the outputs of the plurality of photon sources.

The precise type of photon source used is not critical and any suitable type of source may be used, employing any suitable photon generating process, such as spontaneous four wave mixing (SPFW) or spontaneous parametric down-conversion (SPDC). Other classes of sources that do not necessarily require a nonlinear material may also be employed, such as those that employ atomic and/or artificial atomic systems, e.g., quantum dot sources or color centers in crystals. In some embodiments, sources are coupled to photonic cavities, e.g., for artificial atomic systems such as quantum dots coupled to cavities. Other types of photon sources also exist for SPWM and SPDC, such as optomechanical systems. In some embodiments, the photon sources emit multiple photons already in an entangled state in which case the entangled state generator 100 is not necessary, or alternatively the entangled state generator 100 takes the entangled states as input and generate even larger entangled states.

For the sake of illustration, an example which employs spatial multiplexing of several non-deterministic photon sources is described as an example of a multiplexed photon source. However, many different spatial multiplexing architectures are possible without departing from the scope of the present disclosure. Temporal multiplexing may also be implemented instead of or in combination with spatial multiplexing. Multiplexing schemes that employ log-tree, generalized Mach-Zehnder interferometers, multimode interferometers, chained sources, chained sources with dump-the-pump schemes, asymmetric multi-crystal single photon sources, or any other suitable type of multiplexed architecture may be used. In some embodiments, the photon source may employ a multiplexing scheme with quantum feedback control.

The foregoing description provides an example of how photonic circuits may be used to implement physical qubits and operations on physical qubits using mode coupling between waveguides. In these examples, a pair of modes may be used to represent each physical qubit. Examples described below may be implemented using similar photonic circuit elements.

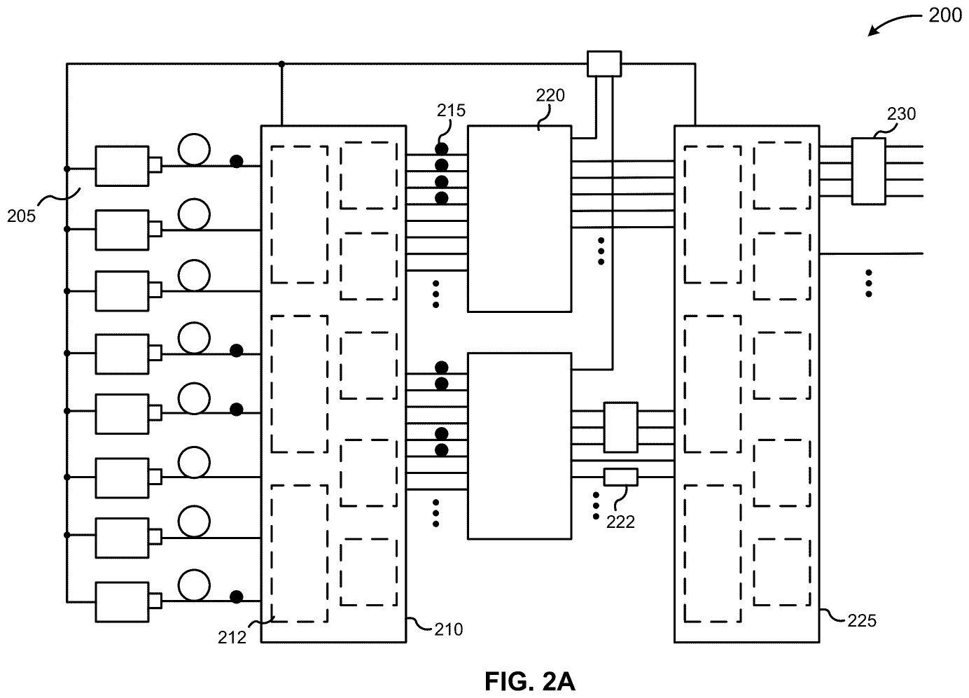

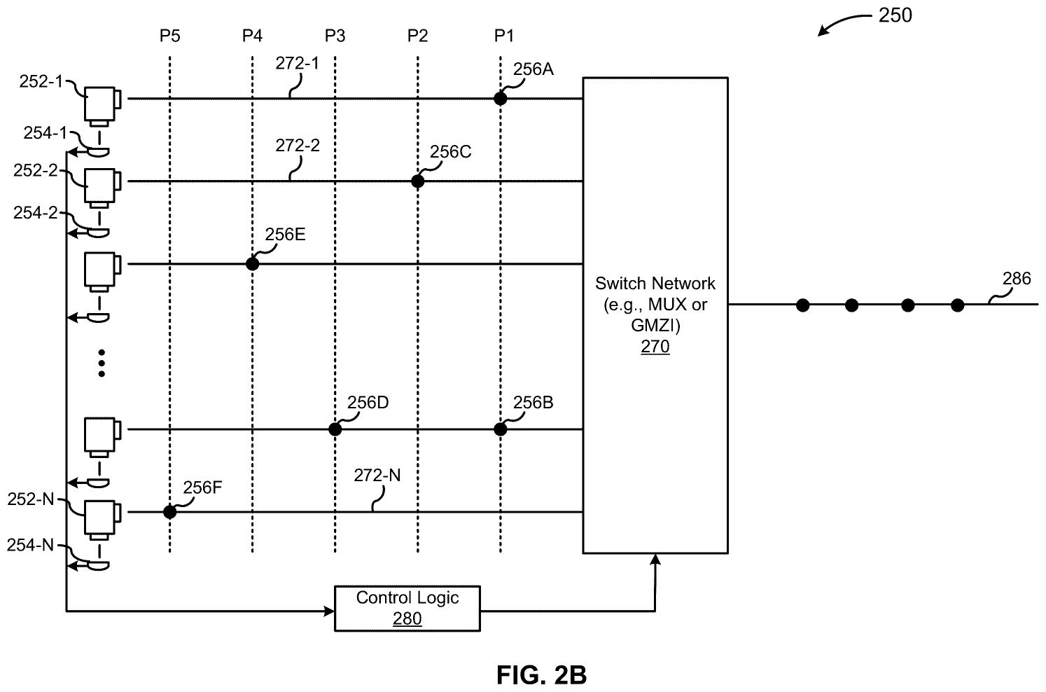

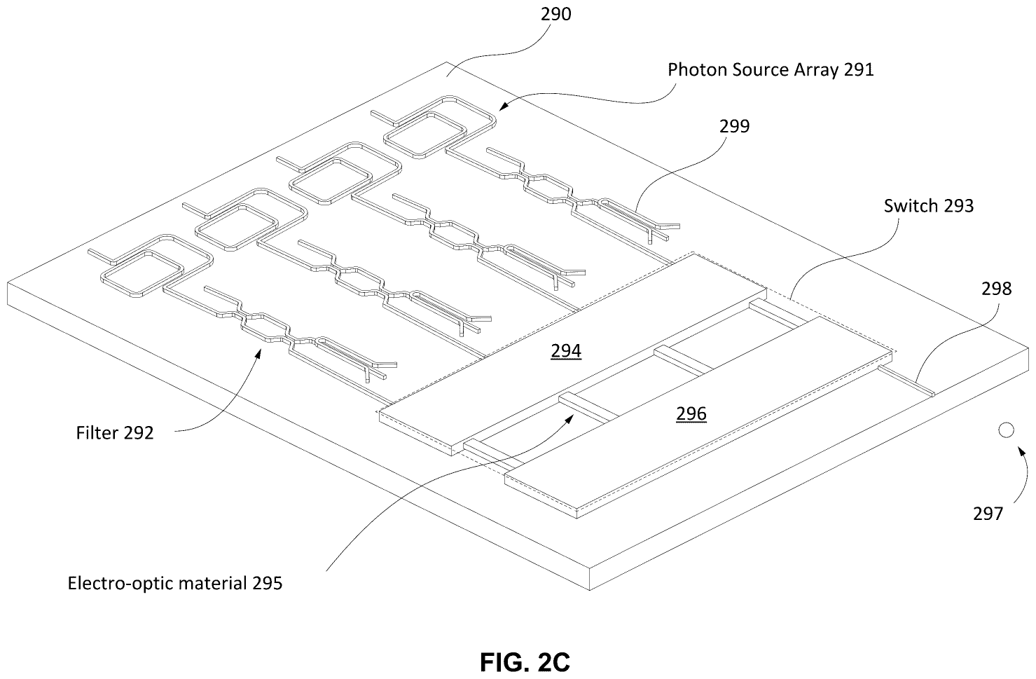

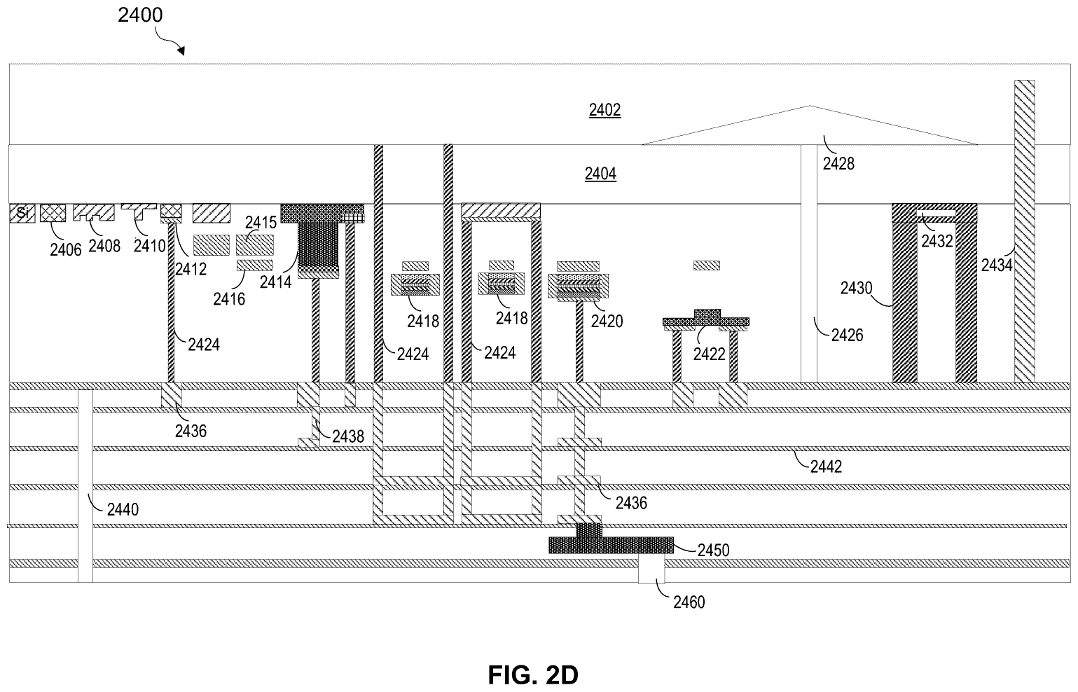

FIG. 2A shows a photonic processing architecture 200 of the photonic switch-based information processing system 101, according to some embodiments. In the example of FIG. 2A, the photonic processing architecture 200 is configured as a spatial multiplexing architecture, although it is appreciated that in other embodiments the photonic architecture is configured for time-based multiplexing that implement time-binned entanglement using switches (e.g., GMZIs). In the example of FIG. 2A, a plurality of optical sources 205 comprise a set of probabilistic optical sources that generate single photons probabilistically (e.g., spontaneous parametric down conversion, four wave mixing, quantum dot generated single photons). In some embodiments, the plurality of optical sources 205 generate pairs of photons and one or more photons in the pairs are detected (e.g., herald photons) to indicate that a successful entangle-able photon has been transmitted towards the first switch network 210. In some embodiments, the detected heralded photons generate source success or fail data bits that are electronically inputted into the first switch network 210 to enable the first switch network 210 to route groups of the entangle-able photons 215 to a photonic entanglement circuit 220 for entanglement. The photonic entanglement circuit 220 receives the entangle-able photons and generates entanglement groups 222 (e.g., photonic resource states comprising three or more entangled photons). In some embodiments, like the plurality of optical sources 205, the photonic entanglement circuit 220 functions probabilistically and successful generation of the entangled groups 222 occurs infrequently. In some embodiments, the photonic entanglement circuit 220 implements one or more optical detections of photons in the photonic entanglement circuit 220 to generate circuit success or fail data that indicates whether a successful entanglement of a group has occurred and further indicates the location of the entangled portions of a given entangled group 222. The circuit success or fail data is electronically communicated to a second switch network 225 for further routing. In some embodiments, the second switch network 225 performs further entanglement operations by merging the entangled photons without detection or otherwise decoherence, such that the switch network outputs one or more entangled qubits 230 for further non-classical optical processing (e.g., quantum communication, quantum experimentation of quantum states, or quantum computing). In some embodiments, the first switch network 210, the photonic entanglement circuit 220, and the second switch network 225 implement optical switches, such as an optical switch 212, to perform both routing and production of photonic entanglements. In some embodiments, the optical switch 212 comprises a generalized Mach-Zehnder interferometer, as discussed in further detail below.

In some embodiments, a Mach Zehnder interferometer comprises a beam splitter that divides an input light into two equal parts which travel on different paths and then combine back together again on a second beam splitter. The path length may be adjusted between the two arms such that the phase difference of classical light input into the Mach Zehnder interferometer may cause all of the light to be outputted from a single output port. In some embodiments, the path length that links the different arms is not adjusted but rather physical characteristics of one or more of the arms are modified to implement phase shifts of the light traversing the given arm, thereby enabling the input light to be outputted from a single output port or both output ports. When classical or “bright light” is an input into a given Mach-Zehnder interferometer (MZI), the MZI may function as a splitter or a guide that guides the classical light towards one or more of the output ports. When non-classical light (e.g., single photons, quantum light) is the input into an MZI, the photon is split and propagates as a superposition of being in each arm at the same time as the photon propagates through the device. As an example, if the MZI is in a 50/50 splitter configuration (e.g., via path length or active phase adjustments), the superposition of the single photon of quantum light is recombined at the second splitter and there is a 50/50 chance of the photon emerging from either output port. Thus, the MZI may function as a classical and non-classical (e.g., quantum) photonic device.

FIG. 2B shows an example source architecture 250, in accordance with some embodiments. The source architecture 250 is an example time-bin switch architecture for increasing a probability of photon generation using non-deterministic sources (e.g., the plurality of optical sources 205 in FIG. 2A) and a switch network 270 (e.g., the first switch network 210 in FIG. 2A or one or more GMZIs). One technique to improve the likelihood of simultaneously obtaining photons from each of a set of non-deterministic photon sources involves spatial multiplexing of multiple photon sources. The source architecture 250 is configured as a N×1 (or N-to-1) multiplexing circuit for a set of N photon sources 252-1, 252-2 through 252-N (e.g., the plurality of optical sources 205) for some number N, where N≥2. In some embodiments, each photon source 252 is a different physical device that may produce a photon pair in response to a pump pulse (e.g., laser pump pulse). For example, each photon source 252 may be a heralded single photon source as described above. The photon sources 252 may be pumped repeatedly, and each instance of the photon sources 252 (e.g., pump sources) may define a time bin (or temporal mode). For each time bin, each photon source 252 may produce a photon pair. Each photon source 252 has an associated detector 254 (e.g., 254-1, 254-2 through 254-N) and an associated signaling waveguide 272 (e.g., 272-1, 272-2 through 272-N). In some embodiments, in any time bin where a particular photon source 252 does produce a photon pair, one photon propagates through the associated signaling waveguide 272 while the other photon is detected by the associated detector 254.

In each time bin, each photon source 252 may generate a photon or photon pair. The dots 256A-256F represent an example of the photons 256 that may be generated during different time bins P1-P5. FIG. 2B may be regarded as a snapshot view, with the photons 256 produced during different time bins appearing at different locations along the signaling waveguides 272 of different waveguide arms.

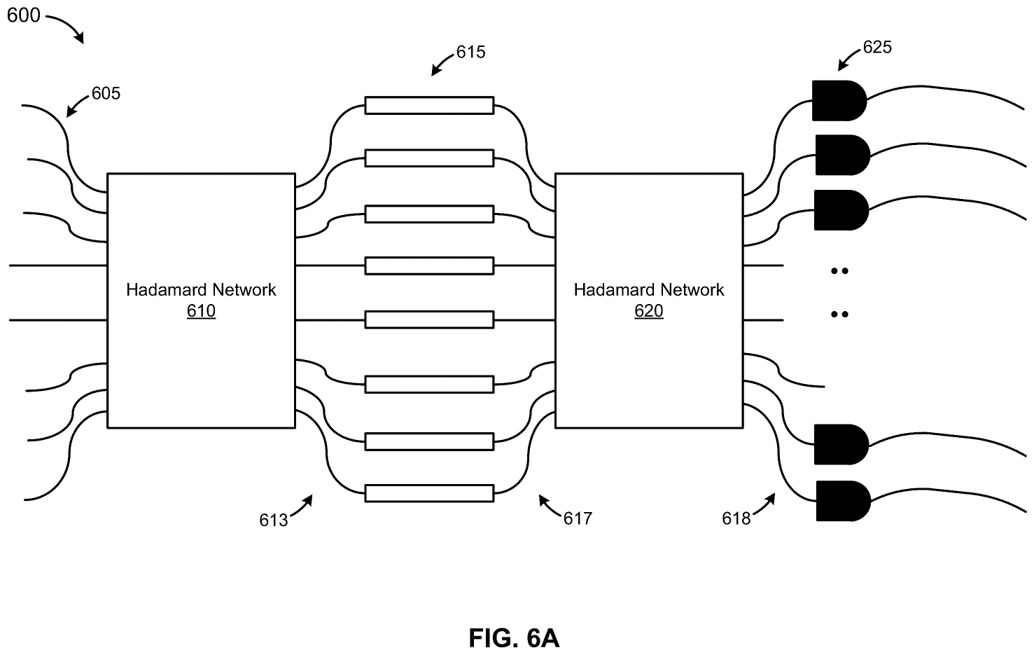

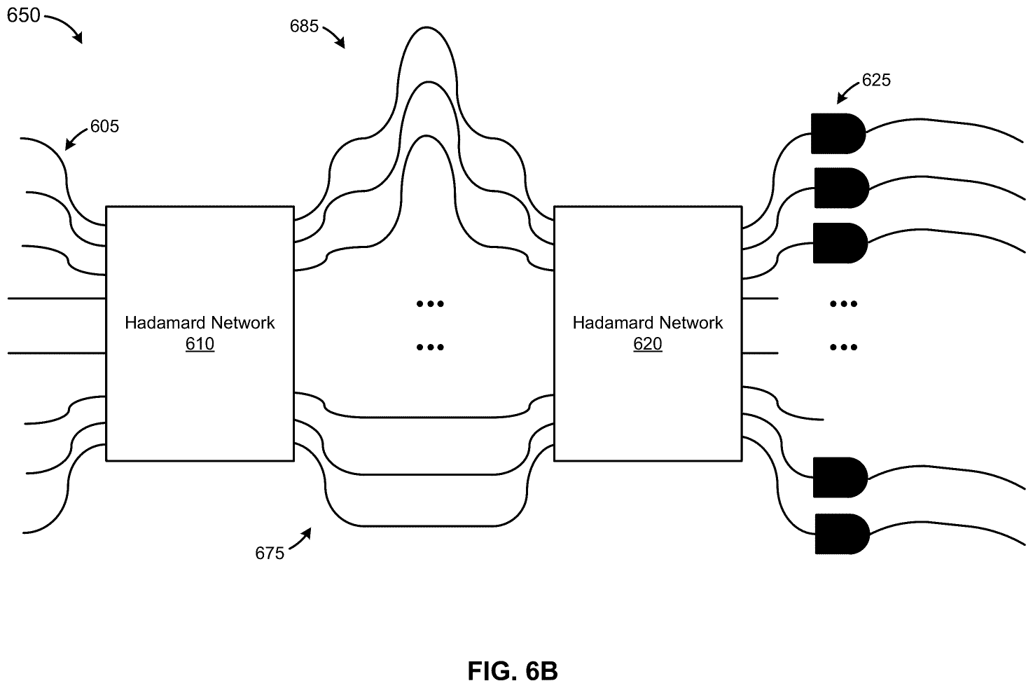

In some embodiments, the switch network 270 is implemented as a N×1 multiplexer (or “mux”) that operates as an active optical switching circuit that selectably couples one of N input waveguides 272 to an output waveguide 286. In some embodiments, selectable optical coupling is provided using active optical switches or other active optical components that may be controlled to either allow or block propagation of photons. For example, a N×1 mux in the switch network 270 can be implemented as an N×1 generalized Mach-Zehnder interferometer (GMZI). In some embodiments, an N×M (or N-to-M) GMZI is an optical circuit that receives photons on a set of N input waveguides and controls a set of active phase shifters to selectably couple M of the received photons to a set of M output waveguides. In some embodiments, one or more of the phase shifters are passive fixed phase shifters for preconfigured phase shifts, as discussed in further detail below with reference to FIG. 6B. In the example of FIG. 2B, the switch network is configured as a M=1 multiplexer that has one output. In some embodiments, the N×1 mux of the switch network 270 is controlled by control logic 280 (e.g., controllers), which can be implemented using a conventional electronic logic circuit. In some embodiments, a control logic 280 receives signals from each of the detectors 254 that indicate, for each time bin, whether a photon was or was not detected by each detector 254. Accordingly, the control logic 280 can determine which of the photon sources 252 produced photons during a given time bin (and therefore which input waveguides 272 are carrying photons for that time bin). For each time bin, the control logic 280 may control the switch network 270 to couple one input waveguide that has a photon to the output waveguide 286. For example, a GMZI includes a set of active phase shifters that can be controlled to apply variable phase shifts along different optical paths, creating either constructive or destructive interference, and the control logic 280 can generate control signals to set the state of each active phase shifter in a GMZI implementing N×1 mux to provide the desired coupling.

In some embodiments, the time bin is as long or short as desired, based on characteristics of the optical circuit or variability in the timing of generating photons in the photon sources 252. In some instances, an interval between time bins may be determined based on the speed at which N×1 mux operations in the switch network 270 can be switched, a recovery time for the photon sources 252 and/or the detectors 254, the operating speed of circuits downstream of the switch network 270, or other design considerations to allow each time bin to be treated as an independent temporal mode.

As noted above, the behavior of the photon sources 252 may be non-deterministic. For example, during a given time bin, the probability of a photon being generated by a given photon source 252 may be represented as pₛ, where pₛ<1. For photon sources of this type, multiplexing as shown in FIG. 2B provides the ability to increase the probability of successfully producing a photon in a given time bin. As shown in FIG. 2B, if N non-deterministic single-photon sources are used, with one photon source coupled to each input of the switch network 270, and if each photon source has probability pₛ of generating a photon (for a given time bin), then the probability that the switch network 270 receives at least one photon is pₘᵤₓ=1−(1−pₛ)\hat{ }N. Thus, for a given type of photon source 252, a desired probability pₘᵤₓ of providing one photon per time bin to the output waveguide 286 may be achieved by a suitable choice of N. Although it is appreciated, as a practical matter, some combinations of pₛ and pₘᵤₓ may require a prohibitively large number N of photon sources.

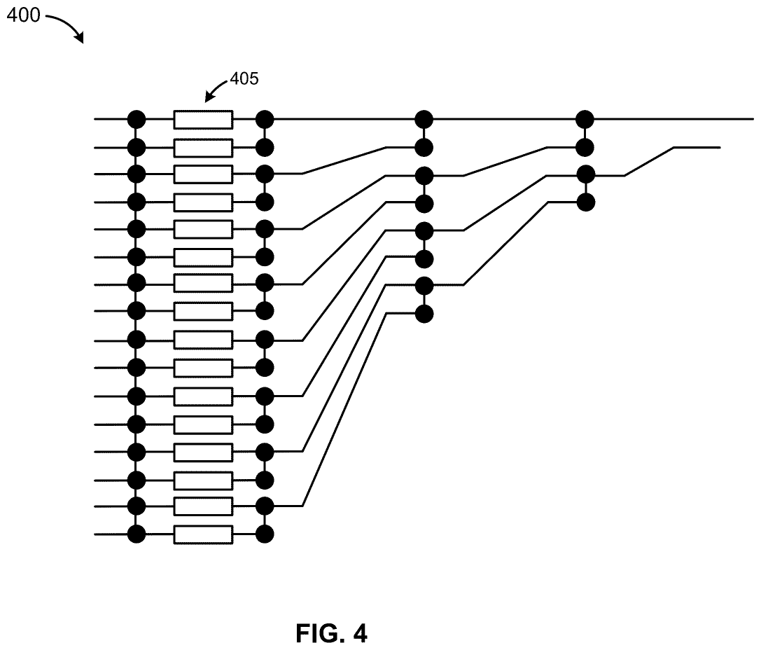

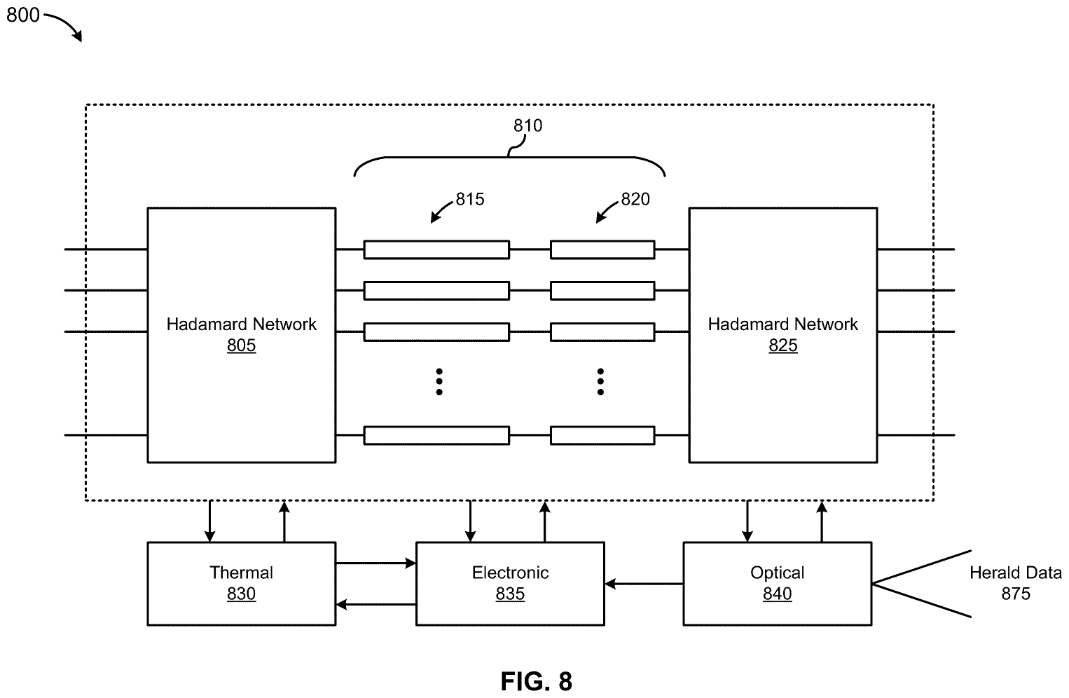

FIG. 2C shows an example of a single photon source photonic integrated circuit (PIC) 290, in accordance with some embodiments. The embodiment of FIG. 2C is an example of a single chip that implements the source architecture 250 of FIG. 2D as discussed above. FIG. 2D shows an example fabrication stack that may be implemented to fabricate the different components shown in the single photon source photonic integrated circuit 290 using existing semiconductor fabrication processes, in accordance with some embodiments. As illustrated in FIG. 2C, the PIC 290 comprises a photon source array 291 that generates photons non-deterministically. In some embodiments, each source in the photon source array 291 comprises a ring resonator and a MZI where an upper portion of the ring resonator functions as the lower arm of the MZI. In some embodiments, each source in the photon source array 291 receives pump light and implements one or more single photon source schemes (e.g., spontaneous four wave mixing, spontaneous parametric down conversion) to non-deterministically generate single photons. In some embodiments, each source in the array comprises a single input and a single output that is coupled to a filter. Each source outputs the pump light and one or more photon pairs into a filter array 292 for filtering. In some embodiments, each filter in the filter array 292 is configured as a pump rejection filter to filter out pump light such that only photon pairs are output from the filter array 292. In some embodiments, one of the photons from each filter impinges on a herald detector to indicate that its counterpart photon (e.g., signal photon) exists and is propagating towards the switch 293 (e.g., a quantum MZI 400 in FIG. 4 or the quantum GMZI switch architecture 800 in FIG. 8). As discussed in further detail below, the switch 293 may include a first quantum optical coupler network 294 (e.g., a Hadamard network) that separates the quantum light onto a plurality of waveguide arms and a second quantum optical coupler network 296 that combines the quantum light in such a way (e.g., via interference) that the quantum light (e.g., single photon 297) is outputted from a single output waveguide 298. In some embodiments, the switch 293 comprises electro-optical material 295 (e.g., BTO, discussed below) that can change the phase of the light on one or more of the given arms to implement a N-to-1 permutation, as discussed in further detail below.

FIG. 2D illustrates an example fabrication stack of a PIC wafer 2400 including various photonic integrated circuit components according to certain embodiments. In the illustrated example, PIC wafer 2400 includes a substrate 2402, buried oxide (BOX) layer 2404, a temperature sensor 2406, a grating coupler 2408, a ridge waveguide 2410, a heater 2412, a Ge photodiode 2414, one or more layers of SiN waveguides 2415 and 2416, one or more superconducting nanowire single photon detectors (SNSPDs) 2418 (e.g., a herald detector 299 in FIG. 2B), and SNSPD contact regions 2420. As described above, the silicon-based circuit components, such as grating coupler 2408, a ridge waveguide 2410, temperature sensor 2406, and the like, may be formed in a silicon on insulator (SOI) layer deposited on the BOX layer 2404. The SiN waveguides 2415 and 2416 may have different thicknesses and different losses, and may be used to form various active and passive photonic integrated circuit components, such as delay lines, phase shifters, ring oscillator, interferometers, switches, filters, and single photon detectors, couplers. The SiN waveguides 2415 and 2416 may receive light from an optical fiber through edge coupling or a grating coupler 2408.

A heater 2412 may include, for example, a silicide layer (such as a nickel silicide layer), a nitride layer (e.g., TiN or NbN), or another resistive material layer, and may be used to tune silicon waveguides. The silicide layer may also be formed in other regions, such as on top of a silicon material region in the SOI layer below a SNSPD 2418, to form part of a scatter mitigation structure. The wafer with these devices and structures may be bonded with a wafer with phase shifters 2422 (e.g., an electro-optical material 295 in FIG. 2C) for BTO switches formed thereon. The substrate of the wafer with the phase shifters 2422 may subsequently be removed and the strontium titanate (SrTiO3, STO) layer of the phase shifters 2422 may be patterned by selective etching.

Electrical contacts 2424 (e.g., through-oxide vias) may be formed in the oxide layers to make electrical connections to the various devices, such as a heater 2412, a Ge photodiode 2414, SNSPDs 2418 and phase shifters 2422. As illustrated in the example, electrical contacts 2424 may include metal trenches surrounding the SNSPDs 2418 to form scatter mitigation structures for blocking stray light as described above.

As also illustrated in FIG. 2D, thermal trenches 2426 and undercut regions 2428 may be formed in the oxide layers and substrate 2402 respectively. Additionally, or alternatively, thermal isolation trenches 2430 and undercut region 2432 may be formed by, for example, etching trenches in the oxide layers to expose certain regions of the SOI layer, and then selectively etching the SOI layer to remove the silicon and form an undercut region. In some embodiments, other structures, such as metal trenches 2434 are formed in the oxide layers and the substrate.

After these structures are manufactured, a PIC wafer 2400 may be processed using the back-end-of-line (BEOL) processes to form one or more metal layers 2436 and vias 2438 (e.g., metal plugs or metal trenches). Some of the vias 2438 may be aligned with some of the electrical contacts 2424 to form the scatter mitigation structures for SNSPDs 2418. In some embodiments, a trench 2440 aligned with a grating coupler 2408 may be etched in the oxide layer to facilitate the coupling of light into the waveguides. For example, an optical fiber may be inserted into the trench 2440 or positioned on the trench 2440 to send light to the grating coupler 2408.

As illustrated in FIG. 2D, one or more etch stop layers 2442 (e.g., SiCN layers) may be used as needed for etching and patterning the metal layers and other structures. The SiCN layers may also be passivation layers for the metal (e.g., copper) in the metal layers. Contact pads 2450 may be formed on the top metal layer (bottom layer shown in FIG. 2D) of PIC wafer 2400. In the illustrated example, trenches 2460 may be etched to form boning balls (not shown in FIG. 2D) for bonding contact pads 2450 with an electronic integrated circuit (EIC) wafer.

The PIC wafer 2400 shown in FIG. 2D includes various passive and active photonic components in a same wafer stack, such as silicon waveguides, SiN waveguides that form parts of other passive or active photonic components (e.g., splitters, filters, delay lines, phase shifters, and single photon sources), grating couplers, Ge photodetectors, single photon detectors, low power BaTiO3 (BTO) phase shifters/switches, temperature sensors, and heaters. Thus, the PIC wafer 2400 may be used to perform various functions for optical quantum computing, such as single photon generation, photon entanglement, fusion, qubit storage, resource state generation, single-photon and multi-photon measurement, and data communication. The PIC wafer 2400 also includes thermal isolation structures (e.g., undercut regions 2428 and trenches 2426) for thermally isolating, for example, the heaters from other components. The undercut regions 2428 may be formed in a large region in a substrate 2402 to thermally isolate components in a large region. Undercut regions (e.g., the undercut region 2432) may additionally or alternatively be formed in an SOI layer. The PIC wafer 2400 further includes scattered light mitigation structures formed by metal layers, a silicide layer, and through-oxide vias or trenches, to isolate, for example, the single photon detectors from stray light.

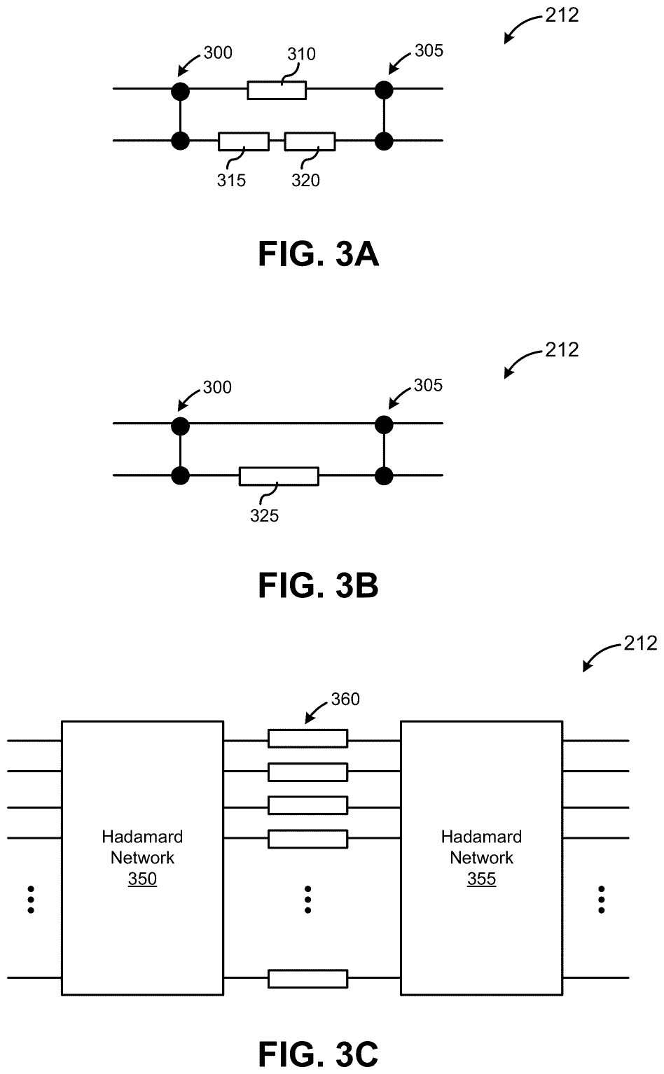

The following are embodiments of MZI based switches, in accordance with some embodiments. In particular, for example, FIG. 3A-3B show implementations of the optical switch 212 configured as an MZI in the first switch network 210 and the second switch network 225, in accordance with some embodiments. It is appreciated that each switch in the first switch network 210 and the second switch network 225 may each be implemented as an individual MZI illustrated in FIGS. 3A-3C and as further discussed in further detail below.

A Mach-Zehnder Interferometer is a network that may be configured to apply identity or swap operations on two inputs. For example, to switch between transfer matrices which are pairs of Pauli operations using active phase shifters:

I or X=h(I or Z)h=Sh_{c}(Z or I)h_{c}S

I or Y=Sh(I or Z)hS^{\}=Zh_{c}(Z or I)h_{c}

where h=(₁¹ ₋₁¹)/\sqrt{2}, h_{c}=(₋ᵢ¹ ₁⁻¹)/\sqrt{2}, and X=(₁⁰ ₀¹), Y=(ᵢ⁰ ₀⁻ⁱ), Z=(₀¹ ᵢ¹).

FIG. 3A shows an example in which the phase shifters implement −iI/Z and FIG. 3B shows an example quantum GMZI 400 in which the phase shifters implement I/Z, in accordance with some embodiments. With reference to FIG. 3A, the optical switch 212 (e.g., an MZI) comprises a first splitter 300 (e.g., beam splitter, half silver mirrors, directional coupler, a multimode interference (MMI) waveguide, a cross coupler or “star” coupler) and a second splitter 305 (e.g., beam splitter, crystal, half silvered mirror, directional coupler, MMI) that separate the light (e.g., bright light, single photon) onto a top arm and bottom arm and then recombine the light for output on one or both output ports. In the example of FIG. 3A, the top arm comprises an active phase shifter 310 and the bottom arm comprises an active phase shifter 315. Further, the bottom arm comprises a further fixed passive phase shifter 320.

In FIG. 3B, the optical switch 212 comprises the first splitter 300 and the second splitter 305 that separate the light onto the top and bottom arms and then recombine the light for output on one or output ports. Further, in the example of FIG. 3B, MZI comprises a single active phase shifter 325 on the bottom arm to implement π phase shifts.

FIG. 3C illustrates the optical switch 212 implemented as a generalized MZI (GMZI), in accordance with some embodiments. The GMZI is an extension of an MZI with N>2 inputs and M≥1 outputs, shown in FIG. 3C. This configuration allows a set of permutations to be performed on the inputs, thereby configuring the switch as a useful block in the design and construction of composite N-to-1 and N-to-M switch networks. In some embodiments, varying the settings of phase shifters 360 (e.g., active phase shifters) sets specific permutations of the N inputs and routes them to M>1 output ports. There are a number of spatial mux schemes that select one of multiple inputs from distinct locations in space. For example, a GMZI can be configured as a N-to-1 mux, as it allows routing of any input to a single output port. The advantages of this scheme include low constant active phase shifter depth (e.g., depth=1) and low N count. However, the total propagation distance and the number of waveguide crossings increase rapidly with N.

As illustrated in FIG. 3C, the example GMZI comprises a first Hadamard gate 350 or splitter (e.g., etalon, an MMI, a network of directional couplers and waveguide crossings) and a second Hadamard gate 355 or splitter (e.g., etalon, an MMI, a network of directional couplers and waveguide crossings) that split and recombine the light propagating on one or more of a plurality of arms (e.g., eight arms, in an 8×8 GMZI) such that the light is outputted on one or more of the plurality of output ports. Example architecture for the first Hadamard gate 350 and second Hadamard gate 355 are discussed in further detail below.

In a bright light example, the GMZI can operate as a power splitter that splits the beam onto the output ports in a given configuration according to settings of the phase shifters 360. In the single photon quantum light operation, the GMZI splits superpositions of the quantum light onto the output ports for recombination and output according to settings of the phase shifters 360.

FIG. 4 shows an example quantum GMZI 400 configured as a N-to-1 multiplexer configuration that implements a plurality of phase shifters 405, in accordance with some embodiments. The quantum MZI 400 is an example configuration that can collect light (e.g., bright light, quantum light, single photons) from a plurality of optical sources 205 that generate the light with a probabilistically low occurrence to output a single muxed source of light (e.g., muxed quantum light) with a probabilistically higher occurrence. The configuration of the quantum MZI 400 is an example of the optical switch 212 that is implemented in the first switch network 210.

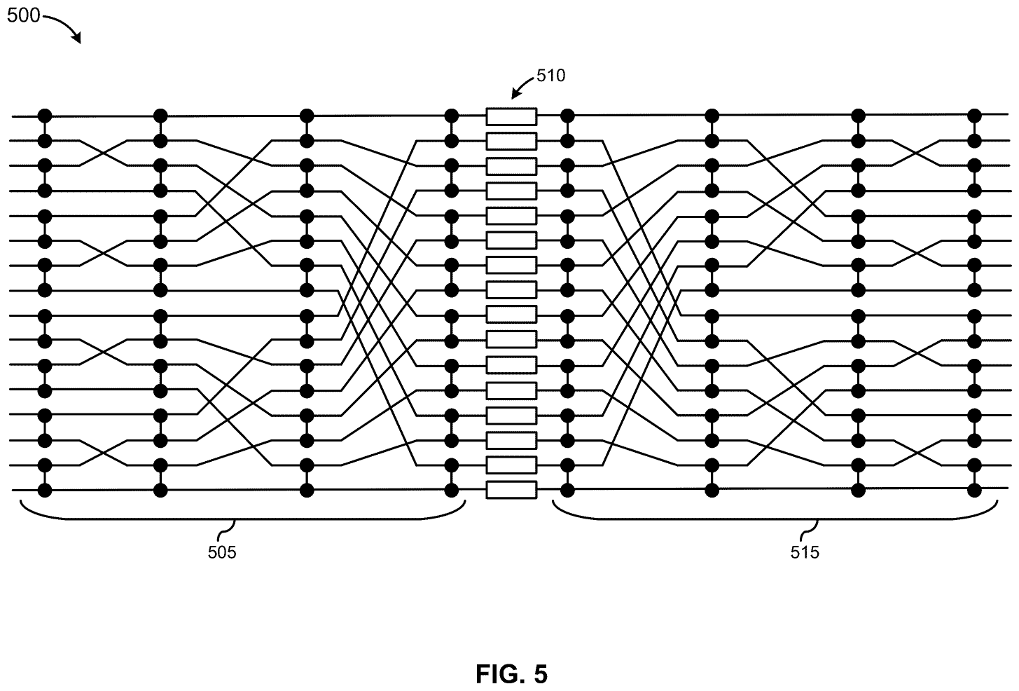

FIG. 5 shows an example linear-optical quantum generalized MZI 500 in a 16×16 configuration, in accordance with some embodiments. The coupler network 505 corresponds to the first Hadamard gate 350 and the coupler network 515 corresponds to the second Hadamard gate 355, which together function as 16-mode Hadamard gate. In some embodiments the plurality of phase shifters 510 are implemented as fast phase shifters that can be set from zero to it shifts to select one of 16 operations (e.g., G([2, 2, 2, 2]). In some embodiments, each phase shifter on each arm comprises two-phase shifter (e.g., a fast phase shifter and a slow phase shifter), as discussed in further detail below with reference to FIG. 8.

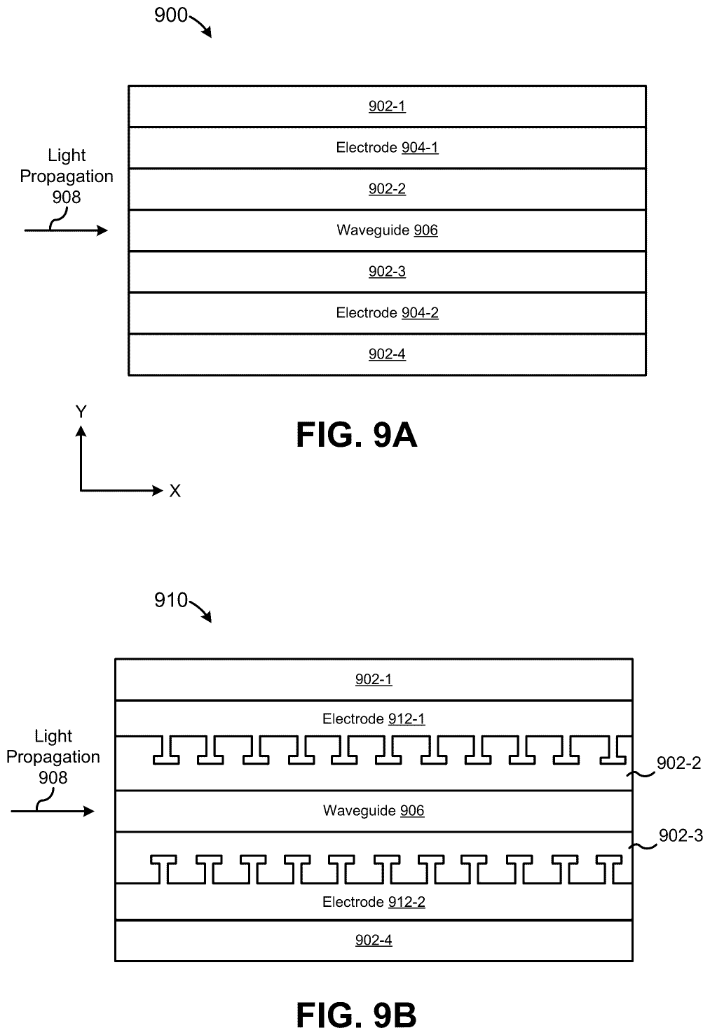

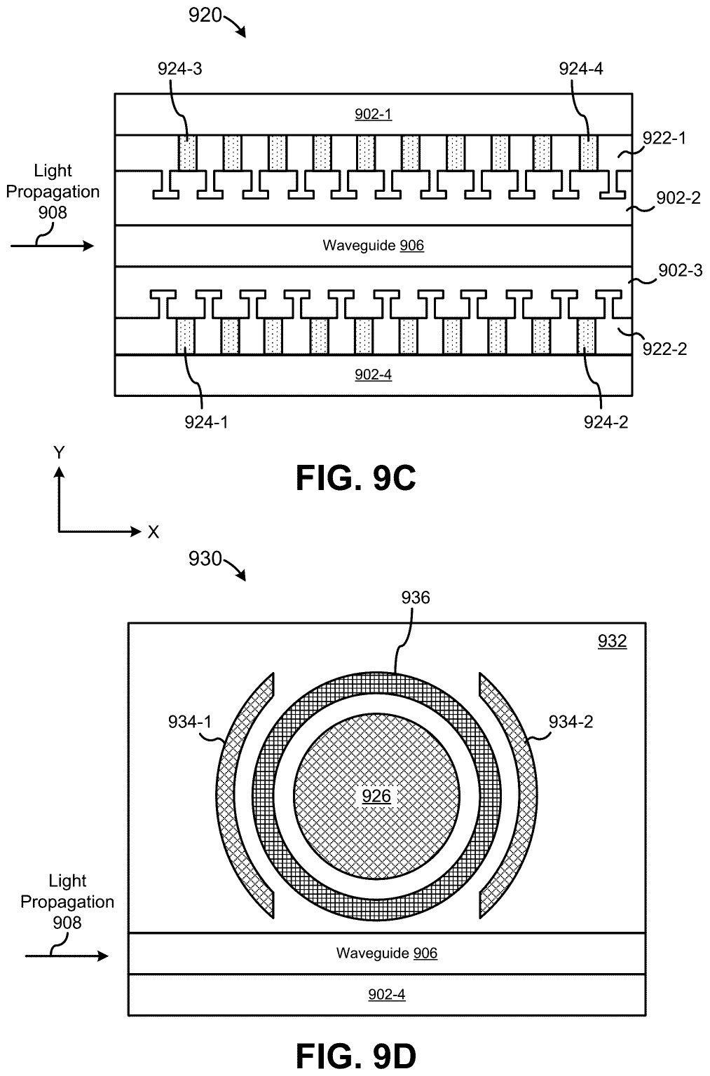

Example architectures for the coupler network 505 and the coupler network 515 are discussed in in further detail below with reference to FIGS. 9-14B. The quantum GMZI 500 is an example optical switch that may process quantum light to generate entanglements in the photonic entanglement circuit 220, generate clustered entanglements in the second switch network 225, in accordance with some embodiments. Further, the MZI is an example optical switch that may be used to route quantum light by configuring the phase shifters 510 in different permutations.

Analytically, the GMZI architectures, such as the quantum MZI 400, the quantum GMZI 500, the quantum GMZI architecture 600, and the quantum GMZI switch architecture 800, are configured to function as a switch network that implements a set of unitary transfer matrices Uₖ, where each unitary routes light between a subset of input and output ports. As an example, if Uₖ is set to route light from port t to port s, then its s^{th} row and t^{th} column are set to zero apart from |U_{s,t}|=1, and similarly for other pairings of input and output ports. The following elucidates example sets of routing operations of a photonic GMZI switch-based information processing architecture, in accordance with some embodiments. In some embodiments, the photonic GMZI switch-based information processing architecture is configured as a scalable waveguide-based switching network that implements transfer matrices using interferometer gates and phase shifters. In some embodiments, the transfer matrices are of the form: Uₖ=W Dₖ V^{†}, where the unitary matrices W, V describe passive interferometers (e.g., the first Hadamard gate 350 and the second Hadamard gate 355 in FIG. 3, and the Dx form a set of diagonal phase matrices (e.g., phases applied to the phase shifters 360, the phase shifters 615, or pairs in the waveguide arm phase shifters 810). In some embodiments, the phase matrices are implemented physically using a single layer of fast phase shifters acting on every waveguide arm (e.g., the phase shifters 615 in FIG. 6 or the fast phase shifters 815 in FIG. 8). In some embodiments, the slow phase shifters are used to zero out a given photonic device.

In the following the phase matrix D implemented in terms of a phase vector d, Dₛ=dₛδ_{s,t} for simplicity. In some embodiments, the photonic GMZI switch-based information processing architecture is configured to function as a scalable switch network that implements different sets of permutation matrices Uₖ=W Dₖ V^{†}, according to desired routing configurations (e.g., to implement a given algorithm or instructions in memory 104, generate entangled states, or perform error correction). By adding the fixed passive network (e.g., a Hadamard gate) corresponding to e.g., U⁻¹ (e.g., the inverse of an arbitrary permutation from that set) a new set of pairwise commuting permutation matrices: {Uₖ U₁⁻¹}=W D′ₖ W^{†}} may be generated. At a high level, and in accordance with some embodiments, the photonic GMZI switch-based information processing architecture is configured as a switch network where {UₖU₁⁻¹}={W Dₖ W^{†}} is a set of transfer matrices corresponding to commuting permutations of N waveguide arms or modes (e.g., N=4 in FIG. 8) for a given switch network configuration. The individual phase shifter settings in Dₖ correspond to given roots of unity (e.g., up to an overall global phase factor e^{iφk} which can be chosen at will). Further, the photonic GMZI switch-based information processing architecture implements one or more GMZI switches with a switch setting Dₖ to route light from input port 1 to output port k.

The embodiments below illustrate example linear-optical photonic circuit GMZI architectures to implement different routing operations G([n₁, n₂, . . . , nᵣ]) on waveguide arms N=Πₗ₌₁^{r}=nₗ:

$${P}_{k} = {( {C}^{( {n}_{1} )} )}^{{k}_{1}} ⊗ {( {C}^{( {n}_{2} )} )}^{{k}_{2}} ⊗ ⋯ ⊗ {( {C}^{( {n}_{r} )} )}^{{k}_{r}}$$

with settings vector k where 0≤kₗ<nₗ with l=1, . . . , r, and further where the transfer matrices W Dₖ W^{†} are as follows:

$$W = {W}^{( {n}_{1} )} ⊗ {W}^{( {n}_{2} )} ⊗ ⋯ ⊗ {W}^{( {n}_{r} )} with {( {W}^{( {n}_{l} )} )}_{s , t} = \frac{{e}^{i2 π st / {n}_{l}}}{\sqrt{{n}_{l}}} ,$$

In the above transfer matrices, the Wⁿ^{ₗ} are discrete Fourier transform (DFT) matrices and the k^{th} setting of the fast phase shifters are set by:

$${D}_{k} = {D}_{{k}_{1}}^{( {n}_{1} )} ⊗ {D}_{{k}_{2}}^{( {n}_{2} )} ⊗ ⋯ ⊗ {D}_{{k}_{r}}^{( {n}_{r} )} , with {( {d}_{k}^{( n )} )}_{s} = {e}^{- i2 π ks / n} for {D}_{k}^{( n )}$$

In some embodiments, scalable networks of GMZI switches are implemented to a large number of modes or waveguide arms, N, with log-depth stages of interference using the following decomposition:

$$W = ( {W}^{( {n}_{1} )} ⊗ {I}^{( N / {n}_{1} )} ) ( {I}^{( {n}_{2} )} ⊗ {W}^{( {n}_{2} )} ⊗ {I}^{( N / ( {n}_{1} , {n}_{2} ) )} ) ⋯ ( {I}^{( N / {n}_{r} )} ⊗ {W}^{( {n}_{r} )} ) = ( {S}_{N / {n}_{1} , {n}_{1}} {I}^{( N / {n}_{1} )} ⊗ {W}^{( {n}_{1} )} {S}_{N / {n}_{1} , {n}_{1}}^{t} ) ( {I}^{( {n}_{1} )} ⊗ {S}_{N / ( {n}_{1} , {n}_{2} ) , {n}_{2}} {I}^{( N / {n}_{2} )} ⊗ {W}^{( {n}_{2} )} {I}^{( {n}_{1} )} ⊗ {S}_{N / ( {n}_{1} , {n}_{2} ) , {n}_{2}}^{t} ) ⋯ ( {I}^{( N / {n}_{r} )} ⊗ {W}^{( {n}_{r} )} )$$

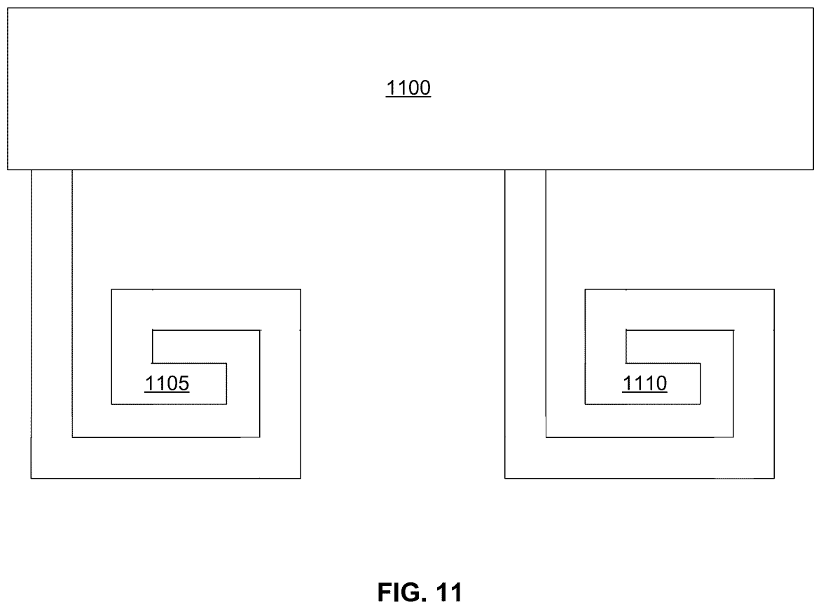

In the above decomposition, the matrices S·,· correspond to crossing networks (e.g., the crossing network 1120 in FIG. 11B) which reorder modes in waveguides in the GMZI. In some embodiments, the subexpressions of the form I^{(N/nl)} I^{(N/n}^{ₗ}⁾⊗Wⁿ^{ₗ} correspond to repeated blocks of modes interfering according to unitary Wⁿ^{ₗ} in the above decomposition, and thus function as stages of local interference separated by crossing networks, such as the crossing network 1120 in FIG. 11B. Further, FIG. 5, discussed above, illustrates an example of Hadamard GMZI implementing the decomposition (e.g., N-to-M permutation), and FIG. 4 illustrates an example of the Hadamard GMZI implementing the GMZI as a simplified N-to-1 mux.

In some embodiments, additional GMZI architectures are implemented by decomposing the unitary matrices W″t that set the design of beam-splitter operations (e.g., the Hadamard gate 350 or the second Hadamard gate 355) and phase-shifter operations (e.g., the phase shifter 615 or the phase shifter set 810). It is appreciated that the optical depth of networks constructed using the recursive decomposition is reliant on high-precision optical hardware and very low optical loss, as the depth of the crossing networks must be accounted for in addition to the stages of local interference (e.g., the depth in crossings of the largest crossing network scales with N/2−1).

FIG. 6A shows an example quantum GMZI architecture 600 in accordance with some embodiments. In the example of FIG. 6, a plurality of waveguide arms input light (e.g., classical light, quantum light) into a first Hadamard gate 610. The output light from the first Hadamard gate 610 is then phase shifted by a plurality of phase shifters 615 and input into a second Hadamard gate 620. In the example configuration of an architecture 600, a single layer of the phase shifters 615 are implemented to perform phase-shift-based light mixing (e.g., bright light mixing, quantum-light probability-distribution adjustments). In some example embodiments, the phase shifts applied comprise 0 to π phase shifts and zero to 2π phase shifts. In some embodiments, the phase shifters are operated in an “in-between” phase-shifter configuration to act an array of beam splitters. In these in-between configuration embodiments, light is input into two target input waveguide arms and can be interfered with 50% of the light transmitted to a given output port where the measurement is made (e.g., via photodetector). In some embodiments, a set of phase shifters are implemented on each arm, as discussed in further detail below with reference to FIG. 8.

Continuing, with reference to FIG. 6 and in accordance with some embodiments, the light adjusted by the second Hadamard gate 620 is outputted from the second Hadamard gate 620 (e.g., from the right side of the second Hadamard gate 620 in the perspective view of FIG. 6A) to one or more detectors 625. Although the example of FIG. 6A shows eight waveguide arms (e.g., eight modes, N=8), it is appreciated that in other embodiments other numbers of waveguide arms may be implemented in a similar manner.

In some embodiments, the one or more detectors 625 are single-photon detectors (e.g., photo-number-resolving detectors) that detect a single photon of light as the photon exits the second Hadamard gate 620. In some embodiments, the photo detectors are bright-light detectors (e.g., phototransistors, photodiodes) that are implemented to detect bright light that is power split onto the plurality of outputs of the second Hadamard gate 620. For example, in some embodiments, bright light is injected into one of the input ports of the second Hadamard gate 620 and is detected from one of the output ports of the second Hadamard gate 620, wherein calibration of the phase shifters 615 are calibrated by modifying the phase shift settings until the phase difference between the input light and the output light is minimized or zeroed out. In some embodiments, a portion of the output bright light is tapped to from the output waveguides of the second Hadamard gate 620 to perform the bright-light-based adjustments and once adjusted, the architecture is configured in quantum light mode whereby single photon detectors (e.g., avalanche photodiodes, photon number resolving detectors, superconducting nanowire detectors) are implemented as the detectors 625 to detect quantum light (e.g., single photons) outputted by the quantum GMZI architecture 600. In some embodiments, once the plurality of phase shifters 615 are zeroed out using bright light, the quantum GMZI architecture 600 is operated in nonclassical quantum light mode, in which single photons or entangled photon groups are propagated through the quantum GMZI architecture 600, and the plurality of phase shifters implement zero to a phase shifters on the superposition of the single photon in the arms of the quantum GMZI architecture 600 to modify probabilities of the quantum light existing from one or more of the output ports (e.g., right side ports) of the second Hadamard gate 620.

In some embodiments, the waveguides of the plurality of arms in the quantum GMZI architecture 600 are designed and fabricated to minimize loss as the respective arms propagate classical or quantum light in the quantum GMZI architecture 600. For example, the waveguides are configured in a fan-in configuration 605 to couple light from multiple larger separate light sources (e.g., the plurality of optical sources 205) into the smaller input interface of the first Hadamard gate 610. Further, the waveguides may be configured in a fan-out architecture 613 to connect the waveguides to the plurality of phase shifters 615 without incurring significant optical loss which can affect quantum light processing (e.g., cause decoherence). Further, the waveguides may be configured in a fan-in architecture 617 into the second Hadamard gate 620 and/or a fan-out configuration 618 to couple to additional devices, such as other switches, further waveguide routing, fiber interfaces, or light detectors (e.g., photodetectors, photodiodes, or the detectors 625).

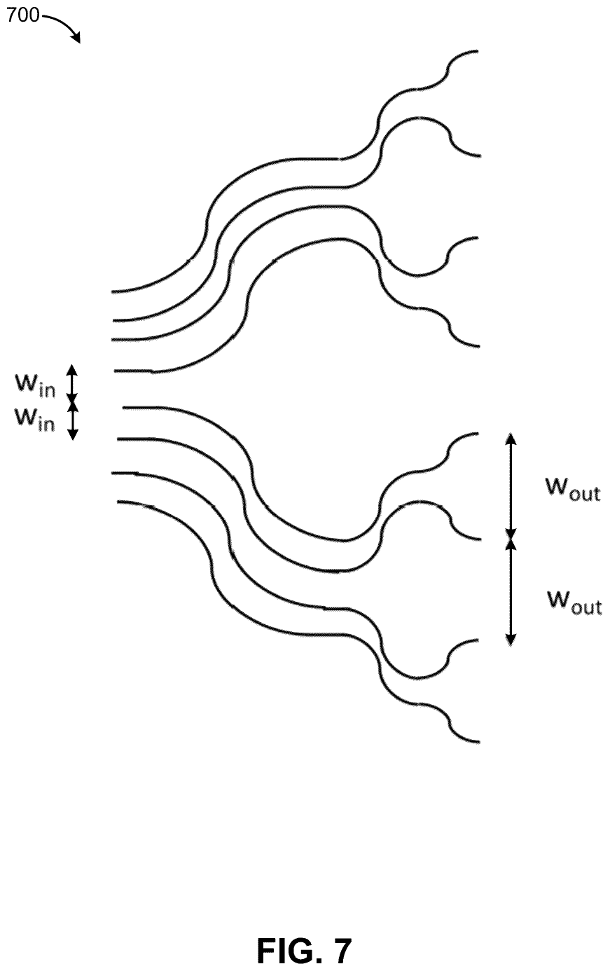

FIG. 6B shows a passive quantum GMZI architecture 650 that implements passive phase shifts, in accordance with some embodiments. In contrast to FIG. 6A, the passive quantum GMZI architecture 650 in FIG. 6B does not implement active phase shifters and instead performs the desired phase shifts using a plurality of top arm waveguides (e.g., fixed passive phase shifters) 685 and a plurality of bottom arm waveguides 675 that have a shape to affect the waveguide length and thereby change the phase of the light traversing the waveguides. In some embodiments, the passive phase shifts in the top arm waveguides (e.g., fixed passive phase shifters) 685 are performed by adding an additional length, ΔL, which is configured to implement a free spectral range that is less than the subcomponents of the Hadamard gates (e.g., the first Hadamard gate 610, the second Hadamard gate 620). In the passive quantum GMZI architecture 650, the wavelength sweep at the input ports may generate a phase shift change across several 2π to enable extinction ratio and measurement of the first Hadamard gate 610 and the second Hadamard gate 620. In some embodiments, the routing of the passive quantum GMZI architecture 650 is dependent on whether the first Hadamard gate 610 and the second Hadamard gate 620 are configured the same or differently (e.g., to implement different unitary operations comprising real transpose or complex conjugation operations). In the example illustrated, the bottom arm waveguides 675 are configured in a log-tree waveguide fan-out and fan-in with straight waveguides to avoid phase differences between the different arms in the bottom arm waveguides 675. Further details of the log-tree fan out and fan-in configuration are discussed with reference to FIG. 7.

FIG. 7 shows an example waveguide fan architecture 700 that may fan-in or fan-out light without incurring significant loss in accordance with some embodiments. In some embodiments, the input pitch, wᵢₙ, is the orientation of the input waveguides and the output pitch, wₒᵤₜ, is the pitch orientation of the waveguide outputs. The inputs and outputs may be connected using segments configured in s-bends (e.g., Euler bends). For example, where the input pitch is smaller and the output pitch is larger (e.g., as in a fan-out configuration), the waveguide fan architecture 700 is configured as a log-tree fanout with segments (e.g., Euler bends, clothoid curves, Euler spiral) of heights, 8s, 4s, 2s, 1s, where s=wᵢₙ−wₒᵤₜ/2, where the wᵢₙ has a height of h, and the wₒᵤₜ has a height of 2 h, in accordance with some embodiments.

FIG. 8 shows a quantum GMZI switch architecture 800, in accordance with some embodiments. As illustrated, light is input into a first Hadamard network (e.g., a first Hadamard gate) 805 and phase shifted by the waveguide arm phase shifters 810. In some embodiments, each phase shifter may be implemented by active optical components built by optical waveguides, such as an electro-optical phase shifter comprising an optical waveguide that is combined with electro-optical materials and electrodes. The optical waveguide of the phase shifter may be fabricated from different materials, including silicon, silicon nitride, doped SiO2, a complex oxide (e.g., lithium niobate, barium titanate), or III-V materials.

In some embodiments, the phase shifter operates by applying an electrical signal (e.g., radio frequency (RF) signaling, microwaves) to the electro-optical material to change its index of refraction and thereby shift the phase of the light propagating in the waveguide. In some embodiments, the application of the electrical signal to the electro-optical material causes a phase shift from plasma dispersion effects in silicon and III-V semiconductors. In some embodiments, the electrical signaling is applied to control a Pockels effect in the shifter (e.g., as in Lithium Niobate and Barium Titanate), or cause Kerr effects. In some embodiments, the active material is resistive and thermal-optical effects cause phase shifts in the propagating light.

In some embodiments, the electrical signaling is applied via electrodes in the phase shifter, where electrodes include different conductive contacts and conductive traces (e.g., metals such as Cu, Al, Au).

In some embodiments, the pitch of the phase-shifter array is increased by fanning out optical waveguides between the Hadamard network gates and the plurality of phase shifters thereby reducing undesired cross-couplings between the separate phase shifters (e.g., minimize thermal or piezo-electric couplings). In some embodiments, the phase shifters are implemented as fast phase shifters and slow phase shifters (e.g., heaters or MEMS switches configured as a phase shifter).

Continuing with reference to FIG. 8, after shifting by the waveguide arm phase shifters 810, the light is then further processed by a second Hadamard network (e.g., the second Hadamard network 825) and output from a plurality of output ports (e.g., to further switches or detectors) of the photonic processing architecture 200. In some embodiments, the components of the quantum GMZI switch architecture 800 are fabricated in a single photonic integrated circuit (e.g., on a single substrate) and the components are interconnected using integrated waveguides (e.g., silicon waveguides, silicon nitride waveguides).

Switching operations: In some embodiments, light (e.g., photons) is inputted into any of the N-input ports (e.g., left side ports of the first Hadamard network 805) and are switched to any of the N-output ports (e.g., right side of the second Hadamard network 825). As discussed, the switching operations may be implemented by the waveguide arm phase shifters 810 including the fast phase shifters 815 and the slow phase shifters 820. In some embodiments, the slow phase shifters are driven by a control system (e.g., the controller 107A, the controller 107B, instructions issued from the classical computer system 103, the microprocessor system, ASIC, or the electrical integrated logic circuit). In some embodiments, the control system comprises a plurality of control subsystems comprising a thermal controller 830, an electrical controller 835, and an optical controller 840. Although the thermal controller 830, the electrical controller 835, and the optical controller 840 are illustrated as external to the quantum GMZI for explanation and clarity purposes, it is appreciated that components of the thermal controller 830, the electrical controller 835, the optical controller 840—such as sensors, waveguides and electrical traces may be integrated throughout the GMZI to detect and control different components.

At a high level, and in accordance with some embodiments, the electrical controller 835 controls the slow phase shifters (e.g., sets biases) to tune and zero out the architecture (e.g., the quantum GMZI switch architecture 800, the photonic processing architecture 200), and the electrical controller 835 controls the fast phase shifters to finish switching operations (e.g., 0 to π phase shifts to implement transform matrices or dynamic updates for error correction).

In some embodiments, during operation, the performance of the fast phase shifters 815 and/or the slow phase shifters 820 may drift or degrade with time. The optical controller 840 may be configured to detect optical signals (e.g., from bright light, herald data 875 from single photon detectors, or single photons such as idler photons) and provide feedback to the electrical controller 835. The electrical controller 835 may then adjust the phase shifter driving signals in the control circuits and the drivers to configure (e.g., bias) the phase shifters to compensate for the drifts or performance degradation.

In some embodiments, the phase shifters are sensitive to local temperature gradient of the environment in which the quantum GMZI switch architecture 800 operates. In some embodiments, throughout the operation, the temperature sensors in the thermal controller 830 monitors the temperature at different locations of the quantum GMZI switch architecture 800 (e.g., the local temperatures of each phase shifter in the waveguide arm phase shifters 810 or the local temperatures of the first Hadamard network 805 and the second Hadamard network 825). The temperature sensors provide the feedback to the control circuits in the electrical controller 835. If the local temperature needs to be adjusted, the control circuits of the electrical controller 835 comprise logic or instructions to send signals to the heaters in the thermal controller 830 to cause the heaters to heat up the GMZI locally.

In some embodiments, the electrical controller 835 is implemented by electronic integrated circuits comprising logic to implement controls. The integrated circuits may include analog circuits and digital circuits such as high-speed phase shifter drivers, biasing network circuits, monitoring and control circuits. The electronic integrated circuits may be manufactured by different platforms, such as CMOS, SiGe, III-V. In some embodiments, large output extinction ratio are enabled via precise control over phase-shifts in each arm. In some embodiments, the precise control is implemented via programmable DACS that control voltage levels for the slow and fast phase shifters, as well as feedback control for thermal regulation. In some embodiments, schemes such as pre-emphasis and close electrical proximity of driver circuits are implemented by the electrical controller 835 to perform optimization and achieve precise voltage settings for the settings of the fast phase shifters 815.

In some embodiments, the optical controller 840 comprises optical waveguide devices, photodetectors (e.g., bright light photodetectors, monitor photodiodes, single photon detectors) and tapping components (e.g., optical taps or switches configured to activate and tap light from a given waveguide). In some embodiments, the bright-light photodetectors of the optical controller 840 are formed from materials including one or more of: doped silicon, germanium, or superconducting materials. In some embodiments, upon the optical signal being detected by one or more of the photodetectors, electrical signal is then generated from the optical signal and transmitted to the electrical controller 835 for control signal processing.

In some embodiments, the thermal controller 830 comprises a plurality of temperature sensors that detect temperature. For example, the temperature sensors (e.g., thermometers) can be implemented by sensing the electrical signals of different materials, such as DLTM (e.g. doped Si), metals (e.g. Al, Cu, W, TiN, etc.), and electro-optical dielectric materials (e.g. Barium Titanate). When temperature changes, the monitoring and control circuits sense the change of the electric signal (e.g. I-V) of the temperature sensors, and obtain the (local) temperature readings. In some embodiments, the temperature sensors are implemented by the optical signals of different materials, such as Si, SiN, Complex Oxide (e.g. Lithium Niobate, Barium Titanate), or III-V. In an optical resonator implementation, the resonant wavelength is a function of the temperature due to the thermo-optical effect of the materials. In these embodiments, the heater element is formed from materials having resistance, such as doped Si, metals (e.g. Al, Cu, W, TiN, etc.), doped dielectrics.

In some embodiments, each arm in the quantum GMZI switch architecture 800 is controlled by a set of phase shifters: a slow phase shifter 820 and a fast phase shifter 815. At a high level, the slow phase shifter 820 is configured to minimize or zero out a phase difference between input and output light. For example, input light is light inputted into the left side of the first Hadamard network (e.g., the first Hadamard gate) 805 and the output light is light outputted from the right side of the second Hadamard network (e.g., the second Hadamard gate) 825 and measured to perform adjustments. In some embodiments, the slow phase shifters 820 are implemented to configure the quantum GMZI switch architecture 800 for a given optical processing configuration (e.g., zero out fabrication-based loss sources, adjust global phases, or compensate for temperature variations across the optical device). For example, the slow phase shifter 820 is configured to manage local temperature issues, such as the differences between the temperature of different areas of the quantum GMZI switch architecture 800 to ensure the phase differences are zeroed out. Further, in accordance with some embodiments, the slow phase shifters 820 are implemented to zero out phase difference between different GMZIs (e.g., other instances of the quantum GMZI switch architecture 800 that are connected to the GMZI shown in FIG. 8), such that multiple GMZIs arc interconnected and zeroed out across all devices to ensure the fast phase shifters operate with sufficient 0 to π phase shifts in operation.

In some embodiments, one or more of the fast phase shifters 815 are implemented during operation of the quantum GMZI switch architecture 800 to provide precise 0 to π phase shift swings to implement quantum entanglement operations (e.g., apply a desired Hadamard transformation matrix) and to provide routing operations (e.g., routing of bright light, routing of single photons, routing of entangled state photon probability distributions). Although, in FIG. 8, the waveguides are illustrated is straight, it is appreciated that the waveguides may fan-in and fan-out as discussed above (FIG. 7) to minimize loss of optical modes that cause fatal errors in the quantum optical state generation.

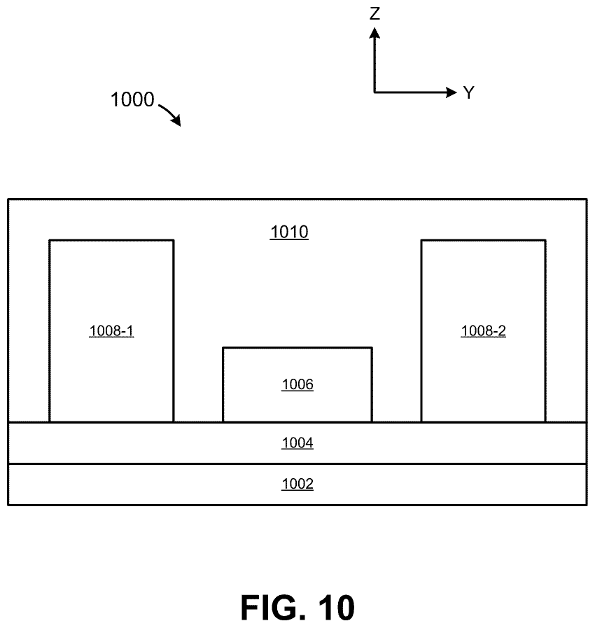

FIGS. 9A-9D are top-down views of example phase shifter configurations in accordance with some embodiments. The top-down views are views from the X-Y plane, where the Z axis is not visible. FIG. 10 shows a different view, in the Y-Z plane, where the X-axis is not visible. With reference to FIG. 9A, FIG. 9A shows a phase shifter 900 that includes electrodes 904 on either side of a waveguide 906 (e.g., in a lumped electrode configuration) in accordance with some embodiments. In some circumstances, the phase shifter 900 can be modeled as a simple capacitor. In the example of FIG. 9A light propagates from left to right through the waveguide 906, along a propagation axis, as indicated by light propagation arrow 908. The electrodes 904 are separated from the waveguide 906 by layers 902 (e.g., portions of a horizontal layer active layer 1004 upon which the electrode and the waveguides are disposed, in some example embodiments). In some embodiments, each of the layers 902 is composed of an active dielectric material, e.g., a ferroelectric material such as BaTiO3 (BTO). In some embodiments, each of the layers 902 is composed of a material having a high dielectric constant (e.g., k greater than or equal to 1000). For example, the electrode 904-1 is separated from the waveguide 906 by a layer 902-2 and the electrode 904-2 is separated from the waveguide 906 by a layer 902-3. In accordance with some embodiments, the phase shifter 900 further includes a layer 902-1 on an opposite side of electrode 904-1 from the layer 902-2, and a layer 902-4 on an opposite side of electrode 904-2 from the layer 902-3. In some embodiments, each of the layers 902 is composed of a same material and is formed together as a horizontal layer (e.g., horizontal layer active 1004 in FIG. 10) In some embodiments one or more of the layers 902 has a different composition than others of the layers 902. For example, the layer 902-1 may have a different percentage of a particular material as compared to others of the layers 902 (e.g., the layer 902-2). As another example, the layer 902-1 may be composed of a different material than others of the layers 902 (e.g., the layer 902-2). In some embodiments, the waveguide 906 is an electro-optical waveguide. In some embodiments, the waveguide 906 is composed of silicon or silicon nitride. In some embodiments, the waveguide 906 is composed of BTO. In some embodiments, each of the electrodes 904 are composed of a same material (e.g., metal, copper metal electrodes). In some embodiments, the electrode 904-1 is composed of a different material than the electrode 904-2. In some embodiments, the electrodes 904 are composed of silicon, doped silicon, germanium, a III-V semiconductor, and/or a complex oxide (such as lithium niobate and/or barium titanate). In some embodiments, the electrodes 904-1 and 904-2 have a same shape (e.g., rectangular) and, optionally, the same dimensions. In some embodiments, the electrodes 904 have non-rectangular shapes (e.g., to increase or decrease capacitance and/or inductance). In some embodiments, at least one of the electrodes 904 has an interdigitated shape (e.g., to increase capacitance and/or inductance).

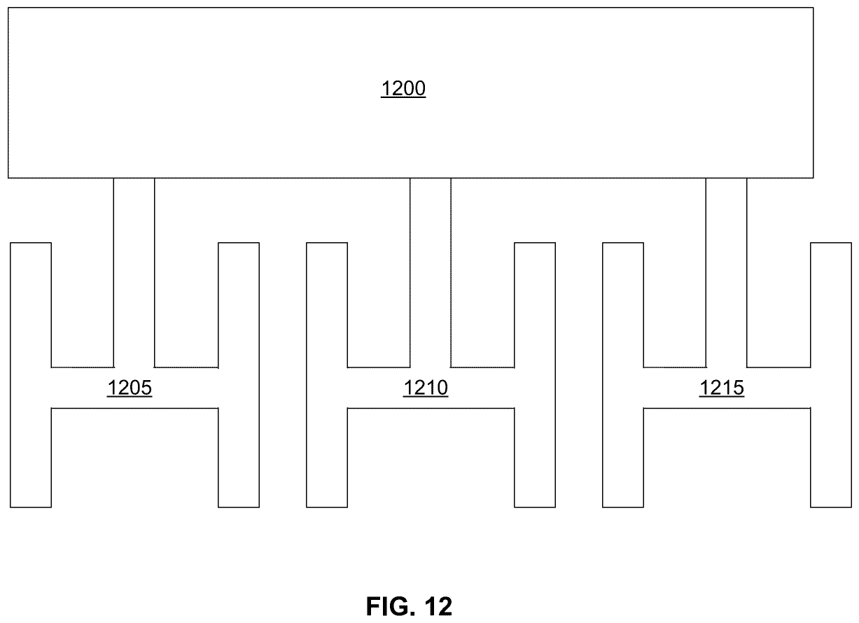

FIGS. 9B-9C show example embodiments in which the electrodes of the phase shifters are shaped to change inductance or capacitance of the electrical wave signaling applied to the electrodes (e.g., electrodes) to better match the optical speed of light propagating in the phase shifter waveguides. In some example embodiments, increasing the capacitance and/or increasing the inductance of the electrodes (e.g., due to the shapes of the electrodes) decreases the electrical waveguide speed. Whereas, and in accordance with some embodiments, decreasing the capacitance and/or decreasing the inductance of the electrodes (e.g., due to shapes of the electrodes) increases the electrical waveguide speed in the electrodes. In some example embodiments, the electrodes have protrusions that have a characteristic capacitance and inductance (e.g., to the protrusions having inductive coil or capacitive plate structures). In some example embodiments, the shape of the repeated electrode protrusions are implemented to match the speed of the electrical signal of the electrodes to the optical speed of light in the electrodes. In some example embodiments, the shape of the repeated protrusions in addition to their density or spacing between each protrusion is designed to increase or decrease capacitance and/or inductance of the signaling in the electrodes to better match the optical wave speed in the waveguides. In some example embodiments, a capacitive protrusion shape (FIG. 11) is configured to increase capacitance for the protrusion (e.g., by exhibiting planar structures that can operate as a capacitive plate to other protrusions which have their own planar regions that operate as capacitive plates). In some example embodiments, a inductor protrusion shape (e.g., FIG. 12) is configured to increase inductance for the protrusion (e.g., by increasing its line width as a line of wire, which can be coiled or shaped otherwise to increase the inductance for the protrusion).

FIG. 9B shows a phase shifter 910 that includes electrodes 912 on either side of the waveguide 906 in accordance with some embodiments. The electrodes 912 each have a distributed shape, for example repeating T-shaped protrusions. In some embodiments, the electrodes 912 (e.g., all, or a certain set of electrodes 912) have a same shape. In some example embodiments, the spacing between the protrusions is modified to change the capacitance/inductance of the electrode (e.g., increasing the spacing between the protrusions to decrease the capacitive and/or inductance of the electrode).

In some embodiments, the electrode 912-1 has a different shape than electrode 912-2. For example, the electrode 912-1 may have a different number, size, and/or spacing of protrusions as compared to the electrode 912-2. In some embodiments, the electrodes 912 are composed of a same material (e.g., the materials described above with respect to the electrodes 904). In some embodiments, each of the electrodes 912 are composed of different materials. In some embodiments, the electrodes 904 and/or 912 operate in a traveling wave configuration. For example, the electrodes are configured such that the electrical speed (velocity) of the signaling applied to the electrodes (e.g., microwave speed) matches an optical speed (velocity) of light propagating in the waveguide. For example, a microwave velocity in the electrodes matches an optical velocity in the waveguide to improve phase shifter performance (e.g., phase shifter bandwidth, phase shifting efficiency).

FIG. 9C shows a phase shifter 920 that includes electrodes 922 on either side of the waveguide 906 in accordance with some embodiments. The electrodes 922 in FIG. 9C are segmented electrodes, segmented by separators 924. In some embodiments, the separators 924 are air gaps that separate each of the segmented electrodes. In some example embodiments, the separators 924 are composed of an active dielectric material (e.g., BTO) or a passivating layer such as silicon dioxide). In some embodiments, the separators 924 are composed of a same material as the layers 902. Although FIG. 9C shows the electrodes 922 having T-shaped protrusions, in some embodiments, the electrodes 922 have other types of protrusions (e.g., rectangular or curved protrusions) or do not include protrusions. In some embodiments, each segment is individually electrically connected to a driver (e.g., via a bump bond). For example, each segment of the electrode 922-1 is connected via bump bond to an electrode to drive the segment, where the plurality of separate segments of the electrode 922-1 are driven independently. In some example embodiments, each segment is connected (e.g., via electrical contact, ball bond, bump bond) to a driver, where the driver comprises an electrical amplifier to receive electrical signaling (e.g., RF) and drive the individual segment. In these embodiments, the electrical speed along the electrode 922-1 is not limited by the inductance and capacitance, but instead limited by the resistance and capacitance of each separated segment (e.g., proportional to the RC time constant of the separated segment) to achieve a wider range of control over the electrical speed of the signaling applied to the electrodes. In some example embodiments, the drivers apply RF signaling to the separated electrodes of FIG. 9C. In some example embodiments, the drivers independently control each separated electrode to trigger them in sequence (e.g., from left to right in FIG. 9C) such that the triggering of the separated protrusions in sequence approximates or matches the optical speed of light in the waveguide.

FIG. 9D shows a phase shifter 930 (e.g., a resonator phase shifter) that includes a ring waveguide 936 optically coupled to the waveguide 906 in accordance with some embodiments. FIG. 9D also shows electrodes 934 on an outside of the ring waveguide 936 and electrode 926 on an inside of ring waveguide 936. In some embodiments, the electrodes 934 and/or 926 are arranged in a lumped electrode configuration. In some embodiments, the electrodes 934 and/or 926 have a distributed shape (e.g., similar to the electrodes 912). For example, the electrodes 934 and/or 926 have T-shaped, rectangular, and/or curved protrusions. In some embodiments, the electrodes 934 and/or 926 are segmented electrodes (e.g., similar to the electrodes 922). In some embodiments, the electrodes 934 and/or 926 are composed of silicon, doped silicon, germanium, a III-V semiconductor, and/or a complex oxide (e.g., lithium niobate and/or barium titanate). In some embodiments, the phase shifter 930 is a ring resonator, a racetrack resonator, or a disk resonator. In some embodiments, light in the ring waveguide 936 is phase shifted as it travels through the ring waveguide 936 (e.g., based on an electrical field generated via the electrodes 934 and 926). In some embodiments, a probability of light coupling out of the ring waveguide 936 is dependent on a phase of the light. For example, the light in the ring waveguide 936 travels in multiple loops through the ring waveguide 936 until a phase of the light is in a range that allows the light to couple out of the ring waveguide 936.

Although FIGS. 9A-9D show the waveguide 906 having a (straight) rectangular shape, in some embodiments, the waveguide 906 has a non-rectangular shape. For example, the waveguide 906 may have a curved (e.g., meandering) shape. In some embodiments, a width of the waveguide 906 is configured to adjust an optical speed of light in the waveguide. For example, the waveguide 906 may include alternating wide and narrow sections (e.g., to adjust a speed of photons in those sections). In some embodiments, the waveguide is configured to slow light (e.g., a photonic crystal waveguide), e.g., to match velocity with the electrodes for better device performance.

In some embodiments, the phase shifters described above with respect to FIGS. 9A-9D (e.g., the phase shifters 900, 910, 920, and 930) are instances of any of the phase shifters described previously (e.g., the phase shifters 310, 315, 320, 325, 360, 405, 510, 615, 815, or 820; phase shifters of electro-optic material 295 on each arm of the switch 293). In some embodiments, the electrodes described herein (e.g., the electrodes 904, 912, 922, and/or 934) are configured to apply an electrical field to a waveguide (e.g., the waveguide 906 and/or 936) to change an index of refraction for the waveguide.

In some embodiments, the electrodes described herein are configured to apply a magnetic field to the waveguide to change an index of refraction for the waveguide. In some embodiments, the electrodes described herein are configured to apply heat (thermal energy) to the waveguide to change an index of refraction for the waveguide. Changing the index of refraction for the waveguide corresponds to a change in the phase of light (photons) traveling through the waveguide. A phase shift value of the phase shifter may be based on one or more of: a material of the electrodes, a capacitance value of the electrodes, an inductance value of the electrodes, a material of the electrodes, a length of the phase shifter, a gap between the electrodes, and/or a material of the layers 902 (e.g., a dielectric constant). In some embodiments, a microwave terminator is coupled to one or more of the electrodes (e.g., a 50-ohm resistor). In some embodiments, a straight phase shifter (e.g., the phase shifter 900) is used for one or more fast phase shifters (e.g., the phase shifters 815) and a resonator phase shifter (e.g., the phase shifter 930) is used for one or more slow phase shifters (e.g., the phase shifters 820).

FIG. 10 illustrates a cross-section view of a phase shifter 1000, in accordance with some example embodiments. The cross-section view of FIG. 10 is down the axis of light propagation (e.g., whereas in FIGS. 9A-9D the light propagation 908 direction (x-axis) is from left to right, in FIG. 10 the light propagation direction is into-the-page, so to speak). As illustrated in FIG. 10, the phase shifter 1000 (e.g., phase shifter 910, FIG. 9B) comprises a waveguide 1006 (e.g., silicon waveguide, silicon nitride waveguide) that is disposed on an active layer 1004 of electro-optic material, e.g., ferroelectric material. The active layer 1004 can be formed from material including one of: one of strontium titanate (STO), barium titanate (BTO), barium strontium titanate (BST), hafnium oxide, lithium niobite, zirconium oxide, titanium oxide, graphene oxide, tantalum oxide, lead zirconium titanate (PZT), lead lanthanum zirconium titanate (PLZT), strontium barium niobate (SBN), aluminum oxide, aluminum oxide, or doped variants or solid solutions thereof.

In propagating down the waveguide 1006 the mode of the light can couple into the active layer 1004. Further illustrated in FIG. 10 are a first electrode 1008-1 (e.g., electrode 912-1) and a second electrode 1008-2 (e.g., electrode 912-2, a metal electrode) that apply electric signaling (e.g., RF, microwave) that phase shifts the light that is propagating in the active layer 1004. It is appreciated that due to the cross-sectional view of FIG. 10, the capacitive and/or inductive protrusions are not visible, as they form part of the blocks of the first electrode 1008-1 and the second electrode 1008-2. In some example embodiments, the phase shifter 1000 further comprises a first cladding layer 1002 and a second cladding layer 1010. In some example embodiments, the first cladding layer is disposed upon a substrate upon which the various layers and components the phase shifter 1000 is formed.

FIG. 11 shows portions of an electrode 1100 with inductive protrusions to adjust inductance, in accordance with some example embodiments. The size and number of protrusions can be adjusted in a given photonic design to match the optical speed of light in the waveguide. In the example illustrated in FIG. 11, electrode 1100 is a close-up example of electrodes of FIG. 9B (e.g., electrode 912-1). Although only two protrusions are shown in FIG. 11, it is appreciated that the electrode 1100 may have different quantities of protrusions, as shown in FIGS. 9B and 9C. In the example of FIG. 11, the electrode has protrusions that are shaped to increase inductance and change the speed of the electrical signaling in the electrode to better match an optical speed of light in the waveguide (not depicted in FIG. 11). In particular, the protrusion 1105 and 1110 are each formed with into a coil shape to increase the inductance of each protrusion and thereby increase the inductance per length along the propagation axis of the phase shifter (e.g., from left to right in FIG. 11, see also FIGS. 9A-9D). In some example embodiments, the longer the length of the coil of a given protrusion (to create more coils, or more loops in the coil) further increases the inductance.

FIG. 12 shows portions of an electrode 1200 with capacitive protrusions to adjust capacitance, in accordance with some example embodiments. In the example illustrated in FIG. 12, electrode 1200 is a close-up example of electrodes of FIG. 9B (e.g., electrode 912-1). Although only three protrusions are shown in FIG. 12, it is appreciated that the electrode 1100 may have different quantities of protrusions, as shown in FIGS. 9B and 9C. In the example of FIG. 12, the electrode has protrusions, including protrusion 1205, protrusion 1210, and protrusion 1215 that are shaped with plate areas that face their neighboring protrusion's plate areas, thereby increasing capacitance to change the speed of the electrical signaling in the electrode to better match an optical speed of light in the waveguide (not depicted in FIG. 11), as discussed above.

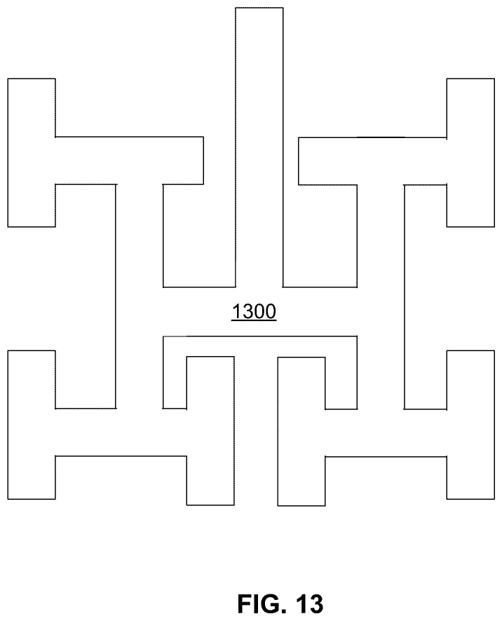

In some example embodiments, each of the protrusions shapes is extended further by adding further orthogonal planar sections to further increase the surface area of a given protrusion and thereby further increase capacitance between the protrusions. For example, in FIG. 13, the example protrusion 1300 is similar to the protrusions of FIG. 12, but with self-similar (e.g., fractal) T-shaped extensions to further increase the surface area of the protrusion 1300 and further increase the capacitance. In some example embodiments, further extensions are added to the ends of the protrusions to further increase capacitance.

Turning now to some embodiments:

Example 1: A method for processing light in an integrated generalized Mach-Zehnder Interferometer (GMZI), the method comprising: receiving, by a first coupler network in the GMZI, a quantum state of light comprising one or more photons; distributing, using the first coupler network, the quantum state of light to one or more of a plurality of waveguide arms in the GMZI; adjusting, using a plurality of phase shifters in the GMZI, one or more phases of the quantum state of light distributed by the first coupler network, a phase shifter of the plurality of phase shifters adjusting a phase portion of the quantum state of light in one of the plurality of waveguide arms, each waveguide arm of the waveguide arms comprising a first phase shifter and a second phase shifter; receiving, by a second coupler network in the GMZI, the quantum state of light having phases adjusted by the plurality of phase shifters; combining, using the second coupler network, the quantum state of light to form combined quantum state of light onto one or more outputs of the waveguide arms; and outputting the combined quantum state of light from the one or more outputs of the waveguide arms.

Example 2: The method of Example 1, wherein the first phase shifter is a switching phase shifter and the second phase shifter is a trim phase shifter.

Example 3: The method of Example 1 or Example 2, wherein the first phase shifter is an electro-optic phase shifter and the second phase shifter is a heat-based phase shifter.

Example 4: The method of any one of Examples 1-3, wherein the first phase shifter is configured to complete phase shifts faster than the second phase shifter.

Example 5: The method of any one of Examples 1-4, wherein the first phase shifter is a BTO based phase shifter and the second phase shifter is a heater.

Example 6: The method of any one of Examples 1-5, wherein first phase shifter is configured to apply a phase shift in a range between a range of zero to π, and wherein the second phase shifter is configured to apply a phase shift in a range between zero to 2π.

Example 7: The method of any one of Examples 1-6, wherein the first phase shifter and the second phase shifter are electro-optic phase shifters that switch approximately at a similar speed, and wherein the second phase shifter is implemented for equalization phase setting to calibrate the GMZI and wherein the first phase shifter is implemented at runtime to switch light that is input into the GMZI.

Example 8: The method of any one of Examples 1-7, wherein the method further comprises: detecting light output by the GMZI using one or more photodetectors; and adjusting a plurality of second phase shifters on the waveguide arms to reduce a difference in phases between the plurality of waveguide arms based on the light detected by the one or more photodetectors.

Example 9: The method of any one of Examples 1-8, wherein temperature variations and optical loss in the GMZI cause differences in phases that are reduced by adjusting a plurality of second phase shifters on the waveguide arms of the GMZI.

Example 10: The method of any one of Examples 1-9, wherein each second phase shifter is used to set an equalization phase setting in the GMZI to process the quantum state of light.

Example 11: The method of any one of Examples 1-10, wherein the equalization phase setting is set based on optical couplings between a first GMZI and a second GMZI.

Example 12: The method of any one of Examples 1-11, further comprising: identifying updated first phase shifter setting data, the updated first phase shifter setting data comprising adjustments to first phase shifters in the GMZI; and adjusting a plurality of first phase shifters on the waveguide arms using the updated first phase shifter setting data.

Example 13: The method of any one of Examples 1-12, further comprising: generating updated first phase shifter setting data based on detection of single photons using one or more single photon detectors.

Example 14: The method of any one of Examples 1-13, wherein the single photons are heralding photons and the quantum state of light comprises corresponding signal photons.

Example 15: A photonic integrated circuit comprising a quantum light switch, the quantum light switch comprising: a first coupler network to receive a quantum state of light comprising one or more photons, the first couple network configured to distribute the quantum state of light to one or more of a plurality of arms of the quantum light switch; a plurality of phase shifters on the plurality of arms of the quantum light switch, the plurality of phase shifters configured to couple the quantum state of light from the first coupler network, a phase shifter of the plurality of phase shifters to adjust a phase of the quantum state of light on one of the plurality of arms, each arm of the plurality of arms comprising a first phase shifter and a second phase shifter; and a second coupler network to couple phase adjusted quantum state of light from the plurality of phase shifters and to combine the phase adjusted quantum state of light in the second coupler network to form combined quantum state of light.

Example 16: The photonic integrated circuit of Example 15, wherein the first coupler network comprises a first plurality of optical couplers to distribute the quantum state of light, and wherein the second coupler network comprises a second plurality of optical couplers to combine the phase adjusted quantum state of light.

Example 17: The photonic integrated circuit of Example 15 or Example 16, wherein the quantum light switch comprises a generalized Mach-Zehnder Interferometer (GMZI) to switch quantum light, wherein the quantum state of light comprises the one or more photons encoded as dual-rail qubits on a pair of waveguides, wherein a pair of the plurality of arms of the quantum light switch comprise the pair of waveguides that propagate the dual-rail qubits.

Example 18: The photonic integrated circuit of any one of Examples 15-17, wherein the first phase shifter and the second phase shifter are electro-optic phase shifters that switch approximately at a similar speed, and wherein the second phase shifter is implemented for equalization phase setting to calibrate the GMZI and wherein the first phase shifter is implemented at runtime to switch light that is input into the GMZI.

Example 19: The photonic integrated circuit of any one of Examples 15-18, wherein the first phase shifter is a switching phase shifter and the second phase shifter is a trim phase shifter.

Example 20: The photonic integrated circuit of any one of Examples 15-19, wherein the first phase shifter is an electro-optic phase shifter and the second phase shifter is a heat-based phase shifter.

Example 21: The photonic integrated circuit of any one of Examples 15-20, wherein one or more photodetectors detect light output from the quantum light switch using one or more photodetectors, and wherein the light detected by the one or more photodetectors is used to adjust a plurality of second phase shifters on the plurality of arms to reduce a difference in phases between the plurality of arms based on the light detected by the one or more photodetectors.

Example 22: The photonic integrated circuit of any one of Examples 15-21, wherein temperature variations and optical loss in the quantum light switch cause differences in phases that are reduced by adjusting the plurality of second phase shifters.

Example 23: The photonic integrated circuit of any one of Examples 15-22, wherein the second phase shifters are used to set a equalization phase setting in the quantum light switch to process the quantum state of light.

Example 24: The photonic integrated circuit of any one of Examples 15-23, wherein the equalization phase setting is set based on optical couplings between a first GMZI and a second GMZI.

Example 25: The photonic integrated circuit of any one of Examples 15-24, further comprising: control circuitry that stores first phase shifter settings data for settings to apply to first phase shifters in response to detecting single photons being input into the quantum light switch.

Example 26: The photonic integrated circuit of any one of Examples 15-25, wherein the control circuitry comprises a look-up table storing the first phase shifter settings, the look-up table storing updated first phase shifter setting data to apply to the first phase shifters based on single photons being input onto one or more arms of the quantum light switch.

Example 27: The photonic integrated circuit of any one of Examples 15-26, wherein the quantum state of light is generated from a photonic integrated single photon source that generates photon pairs, wherein the photon pairs comprise a signal photon and an idler photon, wherein the signal photon is detected and the control circuitry receives electrical signaling to indicate which input of the quantum light switch the corresponding signal photon is being input.

Example 28: The photonic integrated circuit of any one of Examples 15-27, wherein the first phase shifter is configured to complete phase shifts faster than the second phase shifter.

Example 29: The photonic integrated circuit of any one of Examples 15-28, wherein the first phase shifter is a BTO based phase shifter and the second phase shifter is a heater.

Example 30: The photonic integrated circuit of any one of Examples 15-29, wherein first phase shifter is configured to apply a phase shift in a range between a range of zero to π, and wherein the second phase shifter is configured to apply a phase shift in a range between zero to 2π.

Example 31: A photonic integrated circuit (PIC) comprising: a plurality of input ports to input a quantum state of light into the PIC; a waveguide network comprising: a fan-in crossing network to combine the quantum state of light; a set of power splitters that are coupled to the fan-in crossing network; and a plurality of output ports to output the quantum state of light.

Example 32: The PIC of Example 31, wherein the waveguide network is a first waveguide network and wherein the PIC further comprises a second waveguide network, the second waveguide network comprising an additional fan-in crossing network that is coupled to an additional set of power splitters.

Example 33: The PIC of Example 31 or Example 32, further comprising: a third waveguide network that comprises a further fan-in crossing network and a further set of power splitters.

Example 34: The PIC of any one of Examples 31-33, wherein outputs of the first waveguide network and the second waveguide network are coupled to inputs of the third waveguide network.

Example 35: The PIC of any one of Examples 31-34, further comprising a plurality of waveguide bends to couple light from the first waveguide network and the second waveguide network to the third waveguide network.

Example 36: The PIC of any one of Examples 31-35, wherein the quantum state of light comprises one or more single photons, and wherein the one or more single photons are in superposition across the output ports.

Example 37: The PIC of any one of Examples 31-36, wherein the set of power splitters comprise 50/50 optical power splitters.

Example 38: The PIC of any one of Examples 31-37, wherein the set of power splitters comprise directional couplers.

Example 39: The PIC of any one of Examples 31-38, wherein the comprise multimode interference couplers.

Example 40: The PIC of any one of Examples 31-39, wherein the quantum state of light propagates along a propagation direction in the PIC, and wherein the fan-in crossing network comprises a plurality of crossing coupler layers having layer sizes arranged in a decreasing order that decreases along the propagation direction.

Example 41: The PIC of any one of Examples 31-40, wherein each crossing coupler layer comprises a plurality of crossing couplers, wherein a portion of the plurality of crossing couplers have unterminated output ports.

Example 42: The PIC of any one of Examples 31-41, wherein the plurality of crossing couplers comprise multi-mode interference (MMI) couplers.

Example 43: The PIC of any one of Examples 31-42, wherein the MMI couplers are star couplers.

Example 44: The PIC of any one of Examples 31-43, further comprising: a fourth waveguide network that comprises a fan-out crossing network and supplementary set of power splitters that are coupled to the fan-out crossing network.

Example 45: The PIC of any one of Examples 31-44, wherein the quantum state of light propagates along a propagation direction in the PIC, and wherein the fan-out crossing network comprises a plurality of crossing coupler layers having layer sizes arranged in an increasing order that increases along the propagation direction.

Example 46: A method comprising: inputting quantum light into an input interface of a photonic integrated circuit, the input interface comprising a plurality of input ports that input into a waveguide network, the waveguide network comprising a layer of directional couplers, a fan-in crossing coupler network, and a plurality of output ports of an output interface, the layer of directional couplers being coupled to the fan-in crossing coupler network and the fan-in crossing coupler network being coupled to the plurality of output ports; splitting the quantum light using the layer of directional couplers; interfering the quantum light in the fan-in crossing coupler network, the fan-in crossing coupler network comprising a set crossing coupler layers having layer sizes arranged in a decreasing order; and outputting the quantum light at the output interface of the waveguide network, the quantum light being output from one or more of the plurality of output ports based on interference in the fan-in crossing network and which input ports of the plurality of input ports receive the quantum light.

Example 47: The method of Example 46, wherein a first waveguide network comprises the waveguide network, and wherein a second waveguide network is adjacent to the first waveguide network, wherein the second waveguide network comprises an additional layer of directional couplers that are coupled to an additional crossing network to split, interfere, and output additional quantum light to additional output ports of the second waveguide network.

Example 48: The method of Example 46 or Example 47, wherein a third waveguide network is coupled to the first waveguide network and the second waveguide network, the third waveguide network comprising a further layer of directional couplers that are coupled to a further crossing coupler network to form additional quantum light from the quantum light from the first waveguide network and additional quantum light from the second waveguide network.

Example 49: The method of any one of Examples 46-48, wherein the directional couplers and the crossing coupler forms an empty shape, and wherein the second waveguide network and the third waveguide network form a self-similar empty shape that is similar to the empty shape formed by the crossing coupler layers and the directional couplers, and wherein additional scaled up fan-in networks create the self-similar empty shape such that light remains in phase as it is split and propagates across different portions of the first, second or third waveguide networks.

Example 50: An optical phase shifter, comprising: a first electrode having a distributed shape; a second electrode; an optical waveguide arranged between the first electrode and the second electrode; and an electro-optical material arranged between the optical waveguide and the first electrode and between the optical waveguide and the second electrode.

Example 51: The optical phase shifter of Example 50, wherein the electro-optical material is in an active layer, and wherein the optical waveguide is in a waveguide layer that is disposed on the active layer, wherein the first electrode and the second electrode are electrically connected to portions of the active layer.

Example 52: The phase shifter of Example 50 or Example 51, wherein the phase shifter is a traveling wave electrode, and wherein the first and second electrodes are operable to receive radio frequency electrical signaling to implement traveling wave phase shifting to light in the optical phase shifter.

Example 53: The phase shifter of any one of Examples 50-52, wherein the first and second electrodes are configured to have an electrical velocity that matches an optical velocity of the optical waveguide.

Example 54: The phase shifter of any one of Examples 50-53, wherein the second electrode has a distributed shape.

Example 55: The phase shifter of any one of Examples 50-54, wherein the distributed shape of the first electrode comprises an array of elements protruding toward the optical waveguide.

Example 56: The phase shifter of any one of Examples 50-55, wherein the first and second electrodes are configured to apply an electrical field to the electro-optical material such that the electro-optical material causes a phase shift in light propagating in the electro-optical material.

Example 57: The phase shifter of any one of Examples 50-56, wherein the first and second electrodes are configured to apply heat to the optical waveguide to change an index of refraction of the optical waveguide.

Example 58: The phase shifter of any one of Examples 50-57, wherein the first electrode comprises a plurality of electrode segments that are separated by gaps.

Example 59: The phase shifter of any one of Examples 50-58, wherein at least one of the first and second electrodes comprise metal electrodes.

Example 60: The phase shifter of any one of Examples 50-59, wherein the optical waveguide has a non-linear shape between the first and second electrodes.

Example 61: The phase shifter of any one of Examples 50-60, wherein the optical waveguide is a photonic crystal waveguide.

Example 62: The phase shifter of any one of Examples 50-61, further comprising: an electrical source coupled to a first end of the first electrode; and a termination resistor coupled to a second end of the first electrode, the second end being opposite of the first end.

Example 63: The phase shifter of any one of Examples 50-62, wherein the electrical source is further coupled to the second electrode.

Example 64: The phase shifter of any one of Examples 50-63, wherein the optical waveguide comprises a waveguide resonator that is optically coupled to a second waveguide.

Example 65: The phase shifter of any one of Examples 50-64, wherein: the optical waveguide resonator has an elliptical shape; second electrode is arranged inside of the elliptical shape; and the first electrode is arranged outside of the elliptical shape.

Example 66: An electro-optical circuit, comprising: the phase shifter of any one of Examples 50-65; a first waveguide network that is coupled to an input of the optical waveguide; a second waveguide network that is coupled to an output of the phase shifter.

Example 67: The electro-optical circuit of any one of Examples 50-66, wherein the first waveguide network and the second waveguide network are Hadamard waveguide networks.

Example 68: The electro-optical circuit of any one of Examples 50-67, wherein the first coupling component is a 2×2 coupler.

It will also be understood that, although the terms first, second, etc. are, in some instances, used herein to describe various elements, these elements should not be limited by these terms. These terms are used only to distinguish one element from another. For example, a first tuner could be termed a second tuner, and, similarly, a second tuner could be termed a first tuner, without departing from the scope of the various described embodiments. The first tuner and the second tuner are both tuners, but they are not the same tuner.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An optical phase shifter, comprising:
a first electrode having a distributed shape;
a second electrode;
an optical waveguide arranged between the first electrode and the second electrode; and
an electro-optical material arranged between the optical waveguide and the first electrode and between the optical waveguide and the second electrode.

2. The optical phase shifter of claim 1, wherein the electro-optical material is in an active layer, and wherein the optical waveguide is in a waveguide layer that is disposed on the active layer, wherein the first electrode and the second electrode are electrically connected to portions of the active layer.

3. The phase shifter of claim 1, wherein the phase shifter is a traveling wave electrode, and wherein the first and second electrodes are operable to receive radio frequency electrical signaling to implement traveling wave phase shifting to light in the optical phase shifter.

4. The phase shifter of claim 1, wherein the first and second electrodes are configured to have an electrical velocity that matches an optical velocity of the optical waveguide.

5. The phase shifter of claim 1, wherein the second electrode has a distributed shape.

6. The phase shifter of claim 1, wherein the distributed shape of the first electrode comprises an array of elements protruding toward the optical waveguide.

7. The phase shifter of claim 1, wherein the first and second electrodes are configured to apply an electrical field to the electro-optical material such that the electro-optical material causes a phase shift in light propagating in the electro-optical material.

8. The phase shifter of claim 1, wherein the first and second electrodes are configured to apply heat to the optical waveguide to change an index of refraction of the optical waveguide.

9. The phase shifter of claim 1, wherein the first electrode comprises a plurality of electrode segments that are separated by gaps.

10. The phase shifter of claim 1, wherein at least one of the first and second electrodes comprise metal electrodes.

11. The phase shifter of claim 1, wherein the optical waveguide has a non-linear shape between the first and second electrodes.

12. The phase shifter of claim 1, wherein the optical waveguide is a photonic crystal waveguide.

13. The phase shifter of claim 1, further comprising:
an electrical source coupled to a first end of the first electrode; and
a termination resistor coupled to a second end of the first electrode, the second end being opposite of the first end.

14. The phase shifter of claim 13, wherein the electrical source is further coupled to the second electrode.

15. The phase shifter of claim 1, wherein the optical waveguide comprises a waveguide resonator that is optically coupled to a second waveguide.

16. The phase shifter of claim 15, wherein:
the optical waveguide resonator has an elliptical shape;
second electrode is arranged inside of the elliptical shape; and
the first electrode is arranged outside of the elliptical shape.

17. An electro-optical circuit, comprising:
the phase shifter of claim 1;
a first waveguide network that is coupled to an input of the optical waveguide;
a second waveguide network that is coupled to an output of the phase shifter.

18. The electro-optical circuit of claim 17, wherein the first waveguide network and the second waveguide network are Hadamard waveguide networks.

19. The electro-optical circuit of claim 17, wherein the first coupling component is a 2×2 coupler.
